(19) United States
(12) Patent Application Publication
(10) Pub. No.: US 2014/0112537 A1
(43) Pub. Date: Apr. 24, 2014

(54) SYSTEMS AND METHODS FOR INTELLIGENT MONITORING OF THOROUGHFARES USING THERMAL IMAGING

(71) Applicant: FLIR Systems, Inc., Wilsonville, OR (US)

(72) Inventors: Jeffrey D. Frank, Santa Barbara, CA (US); Nicholas Högasten, Santa Barbara, CA (US); Theodore R. Hoelter, Goleta, CA (US); Katrin Strandemar, Rimbo (SE)

(73) Assignee: FLIR Systems, Inc., Wilsonville, OR (US)

(21) Appl. No.: 14/101,224

(22) Filed: Dec. 9, 2013

Related U.S. Application Data
(63) Continuation of application No. PCT/US2012/041755, filed on Jun. 8, 2012.
(60) Provisional application No. 61/495,888, filed on Jun. 10, 2011.
(60) Provisional application No. 61/495,879, filed on Jun. 10, 2011.
(60) Provisional application No. 61/495,873, filed on Jun. 10, 2011.
(60) Provisional application No. 61/545,056, filed on Oct. 7, 2011.
(60) Provisional application No. 61/656,841, filed on Jun. 7, 2012.

(51) Int. Cl. G01V 8/10; H05B 37/02; G01N 21/17

(52) U.S. Cl. CPC G01V 8/10; G01N 21/17; H05B 37/0209; H05B 37/02
USPC 382/103; 315/149

(57) ABSTRACT

Various techniques are disclosed for systems and methods using thermal imaging to intelligently monitor thoroughfares. For example, an intelligent monitoring system may include an infrared imaging module, a processor, a communication module, a memory, and an adjustable component. The system may be mounted, installed, or otherwise disposed at various locations along thoroughfares, and capture thermal images of a scene that includes at least a portion of the thoroughfares. Various thermal image processing and analysis operations may be performed on the thermal images to generate comprehensive monitoring information including an indication of detected objects in the scene and at least one attribute associated with the objects. Various actions may be taken, such as generating various alarms and intelligently adjusting operation of various adjustable devices on thoroughfares, based on the monitoring information. The monitoring information may be shared among multiple instances of the system, and may be communicated to external devices.

### CROSS-REFERENCE TO RELATED APPLICATIONS

This application is a continuation of International Patent Application No. PCT/US2012/41755 filed Jun. 8, 2012 which claims priority to U.S. Provisional Patent Application No. 61/656,841 filed Jun. 7, 2012 and entitled “SYSTEMS AND METHODS FOR INTELLIGENT MONITORING OF THOROUGHFARES USING THERMAL IMAGING” which are both hereby incorporated by reference in their entirety.

International Patent Application No. PCT/US2012/41755 claims the benefit of U.S. Provisional Patent Application No. 61/545,056 filed Oct. 7, 2011 and entitled “NON-UNIFORMITY CORRECTION TECHNIQUES FOR INFRARED IMAGING DEVICES” which is hereby incorporated by reference in its entirety.

International Patent Application No. PCT/US2012/41755 claims the benefit of U.S. Provisional Patent Application No. 61/495,873 filed Jun. 10, 2011 and entitled “INFRARED CAMERA PACKAGING SYSTEMS AND METHODS” which is hereby incorporated by reference in its entirety.

International Patent Application No. PCT/US2012/41755 claims the benefit of U.S. Provisional Patent Application No. 61/495,879 filed Jun. 10, 2011 and entitled “INFRARED CAMERA SYSTEM ARCHITECTURES” which is hereby incorporated by reference in its entirety.

International Patent Application No. PCT/US2012/41755 claims the benefit of U.S. Provisional Patent Application No. 61/495,888 filed Jun. 10, 2011 and entitled “INFRARED CAMERA CALIBRATION TECHNIQUES” which is hereby incorporated by reference in its entirety.

### TECHNICAL FIELD

One or more embodiments of the invention relate generally to thermal imaging devices and more particularly, for example, to the use of thermal images for intelligent monitoring of thoroughfares.

### BACKGROUND

There have been some proposals for, and some limited implementations of, traffic monitoring systems used for active traffic management (e.g., variable speed limits, ramp metering, and traffic light control). These systems typically utilize metal detectors (e.g., induction loops) or pressure sensors embedded in pavement, which are calibrated for large objects to crudely detect passage of vehicles over them. As such, current traffic monitoring systems are typically limited to providing some general description relating to vehicular traffic flow and/or density (e.g., estimated traffic flow rate) on highways, arterial roads, and other major roadways only. While visible-light cameras have been proposed as alternative sensors (e.g., using closed circuit TV cameras at known bottlenecks on major roadways), the detection accuracy of monitoring systems using such sensors is known to be heavily affected by various environmental factors including lighting conditions (e.g., night time, shadows, or glares) and weather conditions (e.g., fog, rain, or snow).

There is also a movement to increase energy efficiency of street lights by replacing gas discharge lamps (e.g., metal-halide lamps, vapor phase lamps) with more energy-efficient light sources such as light-emitting diode (LED) lights. LED lights and other proposed replacement light sources have the added benefit of a short response time to output adjustment (e.g., turn on, off, or adjust illumination intensity to any desired level), which may permit further energy saving as well as reduction of light pollution since the lights can be turned on only when needed and turned off or dimmed when not. To detect when illumination is needed, conventional solutions rely on low resolution motion detectors or proximity sensors. However, these sensors are for simply sensing whether an object is near by, and not capable of providing information with the detail necessary to enable high-level analytics for intelligent, robust, and accurate control of light sources and other adjustable devices found on various types of thoroughfares (e.g., streets, sidewalks, tunnel passages, roadways, and other thoroughfares that may be traveled on by vehicles, pedestrians, and/or cyclists). Conventional traffic monitoring systems are also inadequate in this regard, since they are only suited for general vehicular traffic flow monitoring and/or do not work well when lights are dimmed at night.

### SUMMARY

Various techniques are disclosed for systems and methods using thermal imaging to intelligently monitor thoroughfares (e.g., streets, roadways, passages of tunnels, walkways). For example, an intelligent monitoring system may include an infrared imaging module, a processor, a communication module, a memory, a visible light camera, a global positioning system (GPS) receiver, an electronic compass, and an adjustable component. The system may be mounted, installed, or otherwise disposed at various locations along thoroughfares, and capture thermal images of a scene that includes at least a portion of the thoroughfares. Various thermal image processing and analysis operations may be performed on the thermal images to generate comprehensive monitoring information including an indication of detected objects in the scene and at least one attribute associated with the objects. Various actions may be taken, such as generating various alarms and intelligently adjusting operation of various adjustable devices on thoroughfares, based on the monitoring information. The monitoring information may be shared among multiple instances of the system, and may be communicated to external devices.

In one embodiment, an intelligent monitoring system includes an infrared imaging module disposed at a location along a thoroughfare, the infrared imaging module comprising a focal plane array (FPA) configured to capture thermal images of a scene comprising at least a portion of the thoroughfare; and a processor in communication with the infrared imaging module, the processor configured to analyze the thermal images to determine a presence of one or more objects and at least one attribute associated with the objects in the scene, and generate monitoring information based on the determination of the presence and the attribute.

In another embodiment, an intelligent monitoring method includes capturing, at a focal plane array (FPA) of an infrared imaging module, thermal images of a scene comprising at least a portion of a thoroughfare, wherein the infrared imaging module is disposed at a location along the thoroughfare such that the portion of the thoroughfare is within a field of view (FOV) of the infrared imaging module; analyzing the thermal images to determine a presence of one or more objects and at least one attribute associated with the objects in the scene; and generating monitoring information based on the determination of the presence and the attribute.

The scope of the invention is defined by the claims, which are incorporated into this section by reference. A more complete understanding of embodiments of the invention will be afforded to those skilled in the art, as well as a realization of additional advantages thereof, by a consideration of the following detailed description of one or more embodiments. Reference will be made to the appended sheets of drawings that will first be described briefly.

### BRIEF DESCRIPTION OF THE DRAWINGS

FIG. 1 illustrates an infrared imaging module configured to be implemented in a host device in accordance with an embodiment of the disclosure.

FIG. 2 illustrates an assembled infrared imaging module in accordance with an embodiment of the disclosure.

FIG. 3 illustrates an exploded view of an infrared imaging module juxtaposed over a socket in accordance with an embodiment of the disclosure.

FIG. 4 illustrates a block diagram of an infrared sensor assembly including an array of infrared sensors in accordance with an embodiment of the disclosure.

FIG. 5 illustrates a flow diagram of various operations to determine NUC terms in accordance with an embodiment of the disclosure.

FIG. 6 illustrates differences between neighboring pixels in accordance with an embodiment of the disclosure.

FIG. 7 illustrates a flat field correction technique in accordance with an embodiment of the disclosure.

FIG. 8 illustrates various image processing techniques of FIG. 5 and other operations applied in an image processing pipeline in accordance with an embodiment of the disclosure.

FIG. 9 illustrates a temporal noise reduction process in accordance with an embodiment of the disclosure.

FIG. 10 illustrates particular implementation details of several processes of the image processing pipeline of FIG. 6 in accordance with an embodiment of the disclosure.

FIG. 11 illustrates spatially correlated FPN in a neighborhood of pixels in accordance with an embodiment of the disclosure.

FIG. 12 illustrates a block diagram of an intelligent monitoring system using thermal imaging in accordance with an embodiment of the disclosure.

FIG. 13 illustrates an intelligent monitoring system installed in a street light in accordance with an embodiment of the disclosure.

FIG. 14 illustrates thoroughfares installed with a networked intelligent monitoring system in accordance with an embodiment of the disclosure.

FIG. 15 illustrates an intelligent monitoring system implemented as an electronics module that can be readily incorporated into street lights in accordance with an embodiment of the disclosure.

FIG. 16 illustrates a process for intelligent monitoring of thoroughfares using thermal imaging in accordance with an embodiment of the disclosure.

Embodiments of the invention and their advantages are best understood by referring to the detailed description that follows. It should be appreciated that like reference numerals are used to identify like elements illustrated in one or more of the figures.

### DETAILED DESCRIPTION

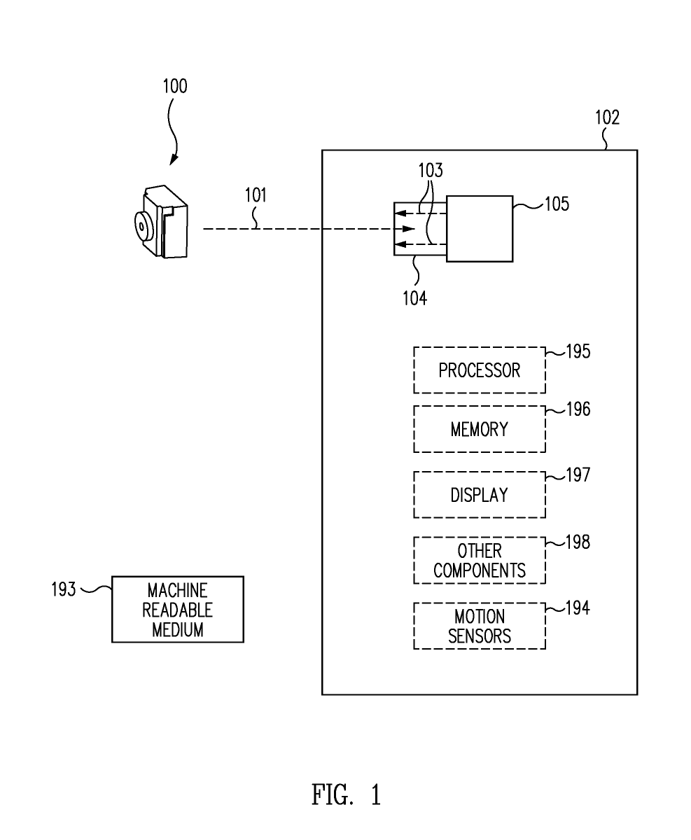

FIG. 1 illustrates an infrared imaging module 100 (e.g., an infrared camera or an infrared imaging device) configured to be implemented in a host device 102 in accordance with an embodiment of the disclosure. Infrared imaging module 100 may be implemented, for one or more embodiments, with a small form factor and in accordance with wafer level packaging techniques or other packaging techniques.

In one embodiment, infrared imaging module 100 may be configured to be implemented in a small portable host device 102, such as a mobile telephone, a tablet computing device, a laptop computing device, a personal digital assistant, a visible light camera, a music player, or any other appropriate mobile device. In this regard, infrared imaging module 100 may be used to provide infrared imaging features to host device 102. For example, infrared imaging module 100 may be configured to capture, process, and/or otherwise manage infrared images and provide such infrared images to host device 102 for use in any desired fashion (e.g., for further processing, to store in memory, to display, to use by various applications running on host device 102, to export to other devices, or other uses).

In various embodiments, infrared imaging module 100 may be configured to operate at low voltage levels and over a wide temperature range. For example, in one embodiment, infrared imaging module 100 may operate using a power supply of approximately 2.4 volts, 2.5 volts, 2.8 volts, or lower voltages, and operate over a temperature range of approximately −20 degrees C. to approximately +60 degrees C. (e.g., providing a suitable dynamic range and performance over an environmental temperature range of approximately 80 degrees C.). In one embodiment, by operating infrared imaging module 100 at low voltage levels, infrared imaging module 100 may experience reduced amounts of self heating in comparison with other types of infrared imaging devices. As a result, infrared imaging module 100 may be operated with reduced measures to compensate for such self heating.

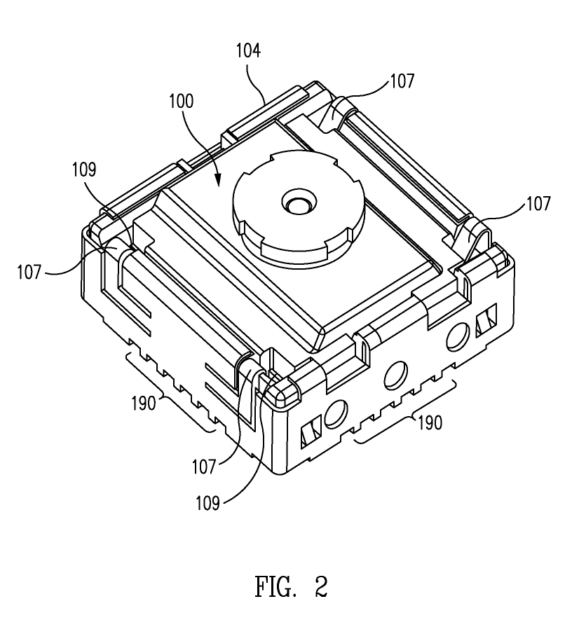

As shown in FIG. 1, host device 102 may include a socket 104, a shutter 105, motion sensors 194, a processor 195, a memory 196, a display 197, and/or other components 198. Socket 104 may be configured to receive infrared imaging module 100 as identified by arrow 101. In this regard, FIG. 2 illustrates infrared imaging module 100 assembled in socket 104 in accordance with an embodiment of the disclosure.

Motion sensors 194 may be implemented by one or more accelerometers, gyroscopes, or other appropriate devices that may be used to detect movement of host device 102. Motion sensors 194 may be monitored by and provide information to processing module 160 or processor 195 to detect motion. In various embodiments, motion sensors 194 may be implemented as part of host device 102 (as shown in FIG. 1), infrared imaging module 100, or other devices attached to or otherwise interfaced with host device 102.

Processor 195 may be implemented as any appropriate processing device (e.g., logic device, microcontroller, processor, application specific integrated circuit (ASIC), or other device) that may be used by host device 102 to execute appropriate instructions, such as software instructions provided in memory 196. Display 197 may be used to display captured and/or processed infrared images and/or other images, data, and information. Other components 198 may be used to implement any features of host device 102 as may be desired for various applications (e.g., clocks, temperature sensors, a visible light camera, or other components). In addition, a machine readable medium 193 may be provided for storing non-transitory instructions for loading into memory 196 and execution by processor 195.

In various embodiments, infrared imaging module 100 and socket 104 may be implemented for mass production to facilitate high volume applications, such as for implementation in mobile telephones or other devices (e.g., requiring small form factors). In one embodiment, the combination of infrared imaging module 100 and socket 104 may exhibit overall dimensions of approximately 8.5 mm by 8.5 mm by 5.9 mm while infrared imaging module 100 is installed in socket 104.

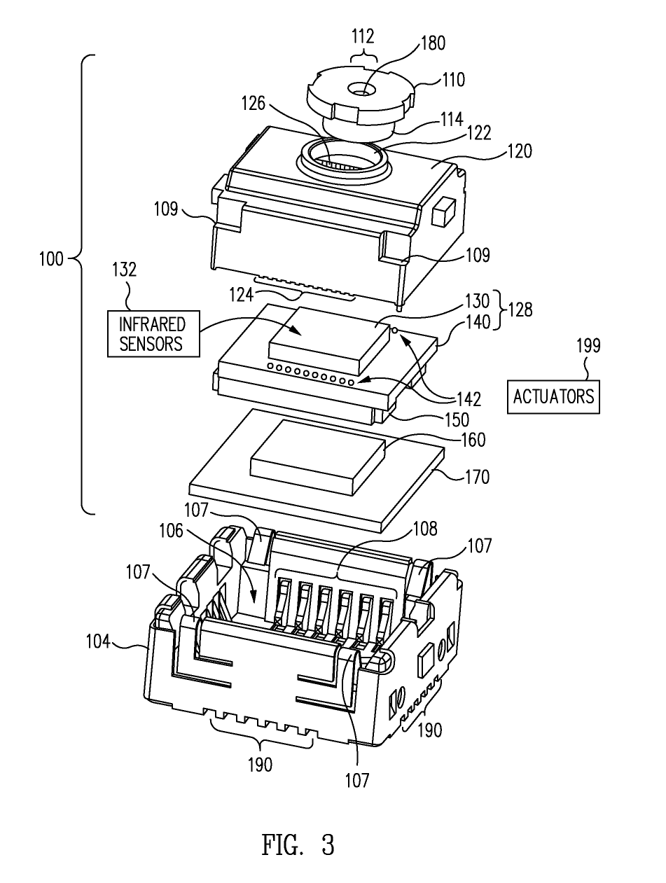

FIG. 3 illustrates an exploded view of infrared imaging module 100 juxtaposed over socket 104 in accordance with an embodiment of the disclosure. Infrared imaging module 100 may include a lens barrel 110, a housing 120, an infrared sensor assembly 128, a circuit board 170, a base 150, and a processing module 160.

Lens barrel 110 may at least partially enclose an optical element 180 (e.g., a lens) which is partially visible in FIG. 3 through an aperture 112 in lens barrel 110. Lens barrel 110 may include a substantially cylindrical extension 114 which may be used to interface lens barrel 110 with an aperture 122 in housing 120.

Infrared sensor assembly 128 may be implemented, for example, with a cap 130 (e.g., a lid) mounted on a substrate 140. Infrared sensor assembly 128 may include a plurality of infrared sensors 132 (e.g., infrared detectors) implemented in an array or other fashion on substrate 140 and covered by cap 130. For example, in one embodiment, infrared sensor assembly 128 may be implemented as a focal plane array (FPA). Such a focal plane array may be implemented, for example, as a vacuum package assembly (e.g., sealed by cap 130 and substrate 140). In one embodiment, infrared sensor assembly 128 may be implemented as a wafer level package (e.g., infrared sensor assembly 128 may be singulated from a set of vacuum package assemblies provided on a wafer). In one embodiment, infrared sensor assembly 128 may be implemented to operate using a power supply of approximately 2.4 volts, 2.5 volts, 2.8 volts, or similar voltages.

Infrared sensors 132 may be configured to detect infrared radiation (e.g., infrared energy) from a target scene including, for example, mid wave infrared wave bands (MWIR), long wave infrared wave bands (LWIR), and/or other thermal imaging bands as may be desired in particular implementations. In one embodiment, infrared sensor assembly 128 may be provided in accordance with wafer level packaging techniques.

Infrared sensors 132 may be implemented, for example, as microbolometers or other types of thermal imaging infrared sensors arranged in any desired array pattern to provide a plurality of pixels. In one embodiment, infrared sensors 132 may be implemented as vanadium oxide (VOx) detectors with a 17 μm pixel pitch. In various embodiments, arrays of approximately 32 by 32 infrared sensors 132, approximately 64 by 64 infrared sensors 132, approximately 80 by 64 infrared sensors 132, or other array sizes may be used.

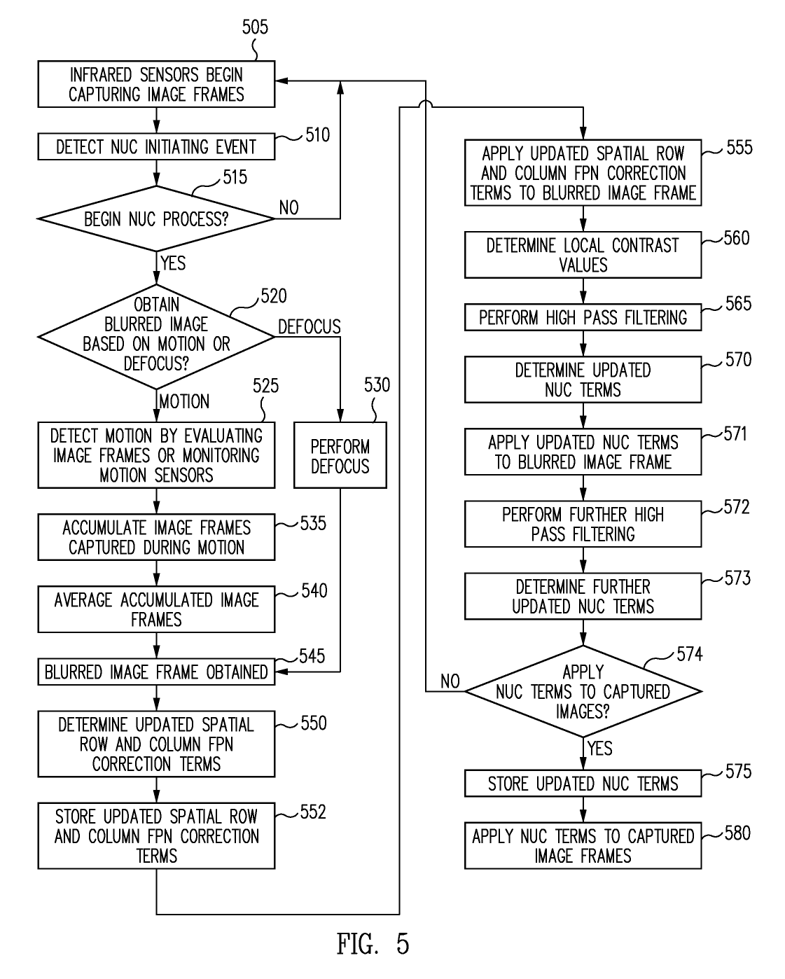

Substrate 140 may include various circuitry including, for example, a read out integrated circuit (ROIC) with dimensions less than approximately 5.5 mm by 5.5 mm in one embodiment. Substrate 140 may also include bond pads 142 that may be used to contact complementary connections positioned on inside surfaces of housing 120 when infrared imaging module 100 is assembled as shown in FIGS. 5A, 5B, and 5C. In one embodiment, the ROIC may be implemented with low-dropout regulators (LDO) to perform voltage regulation to reduce power supply noise introduced to infrared sensor assembly 128 and thus provide an improved power supply rejection ratio (PSRR). Moreover, by implementing the LDO with the ROIC (e.g., within a wafer level package), less die area may be consumed and fewer discrete die (or chips) are needed.

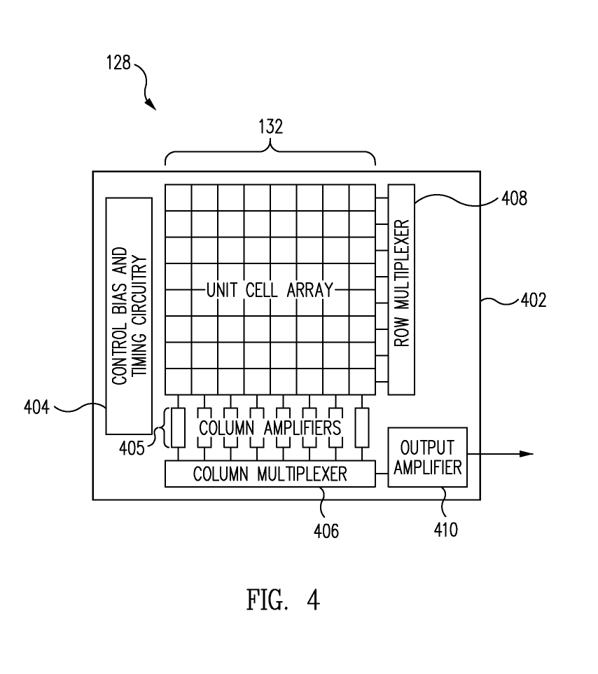

FIG. 4 illustrates a block diagram of infrared sensor assembly 128 including an array of infrared sensors 132 in accordance with an embodiment of the disclosure. In the illustrated embodiment, infrared sensors 132 are provided as part of a unit cell array of a ROTC 402. ROTC 402 includes bias generation and timing control circuitry 404, column amplifiers 405, a column multiplexer 406, a row multiplexer 408, and an output amplifier 410. Image frames (e.g., thermal images) captured by infrared sensors 132 may be provided by output amplifier 410 to processing module 160, processor 195, and/or any other appropriate components to perform various processing techniques described herein. Although an 8 by 8 array is shown in FIG. 4, any desired array configuration may be used in other embodiments. Further descriptions of ROICs and infrared sensors (e.g., microbolometer circuits) may be found in U.S. Pat. No. 6,028,309 issued Feb. 22, 2000, which is incorporated herein by reference in its entirety.

Infrared sensor assembly 128 may capture images (e.g., image frames) and provide such images from its ROTC at various rates. Processing module 160 may be used to perform appropriate processing of captured infrared images and may be implemented in accordance with any appropriate architecture. In one embodiment, processing module 160 may be implemented as an ASIC. In this regard, such an ASIC may be configured to perform image processing with high performance and/or high efficiency. In another embodiment, processing module 160 may be implemented with a general purpose central processing unit (CPU) which may be configured to execute appropriate software instructions to perform image processing, coordinate and perform image processing with various image processing blocks, coordinate interfacing between processing module 160 and host device 102, and/or other operations. In yet another embodiment, processing module 160 may be implemented with a field programmable gate array (FPGA). Processing module 160 may be implemented with other types of processing and/or logic circuits in other embodiments as would be understood by one skilled in the art.

In these and other embodiments, processing module 160 may also be implemented with other components where appropriate, such as, volatile memory, non-volatile memory, and/or one or more interfaces (e.g., infrared detector interfaces, inter-integrated circuit (12C) interfaces, mobile industry processor interfaces (MTPJ), joint test action group (JTAG) interfaces (e.g., IEEE 1149.1 standard test access port and boundary-scan architecture), and/or other interfaces).

In some embodiments, infrared imaging module 100 may further include one or more actuators 199 which may be used to adjust the focus of infrared image frames captured by infrared sensor assembly 128. For example, actuators 199 may be used to move optical element 180, infrared sensors 132, and/or other components relative to each other to selectively focus and defocus infrared image frames in accordance with techniques described herein. Actuators 199 may be implemented in accordance with any type of motion-inducing apparatus or mechanism, and may positioned at any location within or external to infrared imaging module 100 as appropriate for different applications.

When infrared imaging module 100 is assembled, housing 120 may substantially enclose infrared sensor assembly 128, base 150, and processing module 160. Housing 120 may facilitate connection of various components of infrared imaging module 100. For example, in one embodiment, housing 120 may provide electrical connections 126 to connect various components as further described.

Electrical connections 126 (e.g., conductive electrical paths, traces, or other types of connections) may be electrically connected with bond pads 142 when infrared imaging module 100 is assembled. In various embodiments, electrical connections 126 may be embedded in housing 120, provided on inside surfaces of housing 120, and/or otherwise provided by housing 120. Electrical connections 126 may terminate in connections 124 protruding from the bottom surface of housing 120 as shown in FIG. 3. Connections 124 may connect with circuit board 170 when infrared imaging module 100 is assembled (e.g., housing 120 may rest atop circuit board 170 in various embodiments). Processing module 160 may be electrically connected with circuit board 170 through appropriate electrical connections. As a result, infrared sensor assembly 128 may be electrically connected with processing module 160 through, for example, conductive electrical paths provided by: bond pads 142, complementary connections on inside surfaces of housing 120, electrical connections 126 of housing 120, connections 124, and circuit board 170. Advantageously, such an arrangement may be implemented without requiring wire bonds to be provided between infrared sensor assembly 128 and processing module 160.

In various embodiments, electrical connections 126 in housing 120 may be made from any desired material (e.g., copper or any other appropriate conductive material). In one embodiment, electrical connections 126 may aid in dissipating heat from infrared imaging module 100.

Other connections may be used in other embodiments. For example, in one embodiment, sensor assembly 128 may be attached to processing module 160 through a ceramic board that connects to sensor assembly 128 by wire bonds and to processing module 160 by a ball grid array (BGA). In another embodiment, sensor assembly 128 may be mounted directly on a rigid flexible board and electrically connected with wire bonds, and processing module 160 may be mounted and connected to the rigid flexible board with wire bonds or a BGA.

The various implementations of infrared imaging module 100 and host device 102 set forth herein are provided for purposes of example, rather than limitation. In this regard, any of the various techniques described herein may be applied to any infrared camera system, infrared imager, or other device for performing infrared/thermal imaging.

Substrate 140 of infrared sensor assembly 128 may be mounted on base 150. In various embodiments, base 150 (e.g., a pedestal) may be made, for example, of copper formed by metal injection molding (MIM) and provided with a black oxide or nickel-coated finish. In various embodiments, base 150 may be made of any desired material, such as for example zinc, aluminum, or magnesium, as desired for a given application and may be formed by any desired applicable process, such as for example aluminum casting, MIM, or zinc rapid casting, as may be desired for particular applications. In various embodiments, base 150 may be implemented to provide structural support, various circuit paths, thermal heat sink properties, and other features where appropriate. In one embodiment, base 150 may be a multi-layer structure implemented at least in part using ceramic material.

In various embodiments, circuit board 170 may receive housing 120 and thus may physically support the various components of infrared imaging module 100. In various embodiments, circuit board 170 may be implemented as a printed circuit board (e.g., an FR4 circuit board or other types of circuit boards), a rigid or flexible interconnect (e.g., tape or other type of interconnects), a flexible circuit substrate, a flexible plastic substrate, or other appropriate structures. In various embodiments, base 150 may be implemented with the various features and attributes described for circuit board 170, and vice versa.

Socket 104 may include a cavity 106 configured to receive infrared imaging module 100 (e.g., as shown in the assembled view of FIG. 2). Infrared imaging module 100 and/or socket 104 may include appropriate tabs, arms, pins, fasteners, or any other appropriate engagement members which may be used to secure infrared imaging module 100 to or within socket 104 using friction, tension, adhesion, and/or any other appropriate manner. Socket 104 may include engagement members 107 that may engage surfaces 109 of housing 120 when infrared imaging module 100 is inserted into a cavity 106 of socket 104. Other types of engagement members may be used in other embodiments.

Infrared imaging module 100 may be electrically connected with socket 104 through appropriate electrical connections (e.g., contacts, pins, wires, or any other appropriate connections). For example, socket 104 may include electrical connections 108 which may contact corresponding electrical connections of infrared imaging module 100 (e.g., interconnect pads, contacts, or other electrical connections on side or bottom surfaces of circuit board 170, bond pads 142 or other electrical connections on base 150, or other connections). Electrical connections 108 may be made from any desired material (e.g., copper or any other appropriate conductive material). In one embodiment, electrical connections 108 may be mechanically biased to press against electrical connections of infrared imaging module 100 when infrared imaging module 100 is inserted into cavity 106 of socket 104. In one embodiment, electrical connections 108 may at least partially secure infrared imaging module 100 in socket 104. Other types of electrical connections may be used in other embodiments.

Socket 104 may be electrically connected with host device 102 through similar types of electrical connections. For example, in one embodiment, host device 102 may include electrical connections (e.g., soldered connections, snap-in connections, or other connections) that connect with electrical connections 108 passing through apertures 190. In various embodiments, such electrical connections may be made to the sides and/or bottom of socket 104.

Various components of infrared imaging module 100 may be implemented with flip chip technology which may be used to mount components directly to circuit boards without the additional clearances typically needed for wire bond connections. Flip chip connections may be used, as an example, to reduce the overall size of infrared imaging module 100 for use in compact small form factor applications. For example, in one embodiment, processing module 160 may be mounted to circuit board 170 using flip chip connections. For example, infrared imaging module 100 may be implemented with such flip chip configurations.

In various embodiments, infrared imaging module 100 and/or associated components may be implemented in accordance with various techniques (e.g., wafer level packaging techniques) as set forth in U.S. patent application Ser. No. 12/844,124 filed Jul. 27, 2010, and U.S. Provisional Patent Application No. 61/469,651 filed Mar. 30, 2011, which are incorporated herein by reference in their entirety. Furthermore, in accordance with one or more embodiments, infrared imaging module 100 and/or associated components may be implemented, calibrated, tested, and/or used in accordance with various techniques, such as for example as set forth in U.S. Pat. No. 7,470,902 issued Dec. 30, 2008, U.S. Pat. No. 6,028,309 issued Feb. 22, 2000, U.S. Pat. No. 6,812,465 issued Nov. 2, 2004, U.S. Pat. No. 7,034,301 issued Apr. 25, 2006, U.S. Pat. No. 7,679,048 issued Mar. 16, 2010, U.S. Pat. No. 7,470,904 issued Dec. 30, 2008, U.S. patent application Ser. No. 12/202,880 filed Sep. 2, 2008, and U.S. patent application Ser. No. 12/202,896 filed Sep. 2, 2008, which are incorporated herein by reference in their entirety.

Referring again to FIG. 1, in various embodiments, host device 102 may include shutter 105. In this regard, shutter 105 may be selectively positioned over socket 104 (e.g., as identified by arrows 103) while infrared imaging module 100 is installed therein. In this regard, shutter 105 may be used, for example, to protect infrared imaging module 100 when not in use. Shutter 105 may also be used as a temperature reference as part of a calibration process (e.g., a NUC process or other calibration processes) for infrared imaging module 100 as would be understood by one skilled in the art.

In various embodiments, shutter 105 may be made from various materials such as, for example, polymers, glass, aluminum (e.g., painted or anodized) or other materials. In various embodiments, shutter 105 may include one or more coatings to selectively filter electromagnetic radiation and/or adjust various optical properties of shutter 105 (e.g., a uniform blackbody coating or a reflective gold coating).

In another embodiment, shutter 105 may be fixed in place to protect infrared imaging module 100 at all times. In this case, shutter 105 or a portion of shutter 105 may be made from appropriate materials (e.g., polymers or infrared transmitting materials such as silicon, germanium, zinc selenide, or chalcogenide glasses) that do not substantially filter desired infrared wavelengths. In another embodiment, a shutter may be implemented as part of infrared imaging module 100 (e.g., within or as part of a lens barrel or other components of infrared imaging module 100), as would be understood by one skilled in the art.

Alternatively, in another embodiment, a shutter (e.g., shutter 105 or other type of external or internal shutter) need not be provided, but rather a NUC process or other type of calibration may be performed using shutterless techniques. In another embodiment, a NUC process or other type of calibration using shutterless techniques may be performed in combination with shutter-based techniques.

Infrared imaging module 100 and host device 102 may be implemented in accordance with any of the various techniques set forth in U.S. Provisional Patent Application No. 61/495,873 filed Jun. 10, 2011, U.S. Provisional Patent Application No. 61/495,879 filed Jun. 10, 2011, and U.S. Provisional Patent Application No. 61/495,888 filed Jun. 10, 2011, which are incorporated herein by reference in their entirety.

In various embodiments, the components of host device 102 and/or infrared imaging module 100 may be implemented as a local or distributed system with components in communication with each other over wired and/or wireless networks. Accordingly, the various operations identified in this disclosure may be performed by local and/or remote components as may be desired in particular implementations.

FIG. 5 illustrates a flow diagram of various operations to determine NUC terms in accordance with an embodiment of the disclosure. In some embodiments, the operations of FIG. 5 may be performed by processing module 160 or processor 195 (both also generally referred to as a processor) operating on image frames captured by infrared sensors 132.

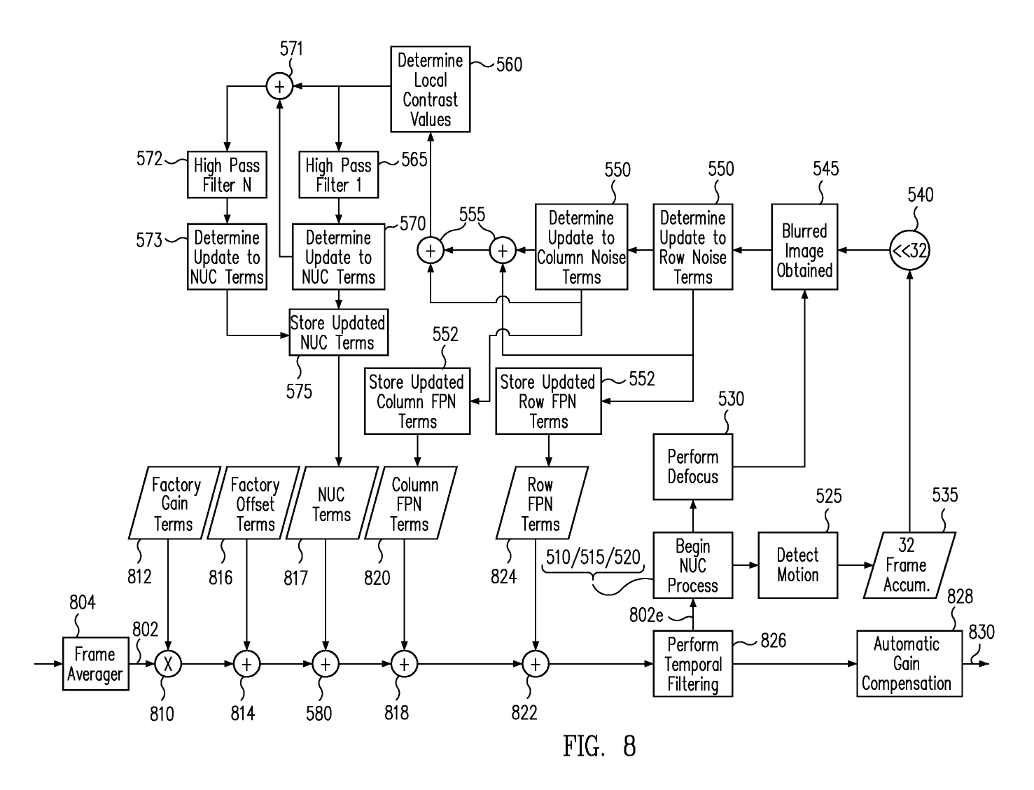

In block 505, infrared sensors 132 begin capturing image frames of a scene. Typically, the scene will be the real world environment in which host device 102 is currently located. In this regard, shutter 105 (if optionally provided) may be opened to permit infrared imaging module to receive infrared radiation from the scene. Infrared sensors 132 may continue capturing image frames during all operations shown in FIG. 5. In this regard, the continuously captured image frames may be used for various operations as further discussed. In one embodiment, the captured image frames may be temporally filtered (e.g., in accordance with the process of block 826 further described herein with regard to FIG. 8) and be processed by other terms (e.g., factory gain terms 812, factory offset terms 816, previously determined NUC terms 817, column FPN terms 820, and row FPN terms 824 as further described herein with regard to FIG. 8) before they are used in the operations shown in FIG. 5.

In block 510, a NUC process initiating event is detected. In one embodiment, the NUC process may be initiated in response to physical movement of host device 102. Such movement may be detected, for example, by motion sensors 194 which may be polled by a processor. In one example, a user may move host device 102 in a particular manner, such as by intentionally waving host device 102 back and forth in an “erase” or “swipe” movement. In this regard, the user may move host device 102 in accordance with a predetermined speed and direction (velocity), such as in an up and down, side to side, or other pattern to initiate the NUC process. In this example, the use of such movements may permit the user to intuitively operate host device 102 to simulate the “erasing” of noise in captured image frames.

In another example, a NUC process may be initiated by host device 102 if motion exceeding a threshold value is exceeded (e.g., motion greater than expected for ordinary use). It is contemplated that any desired type of spatial translation of host device 102 may be used to initiate the NUC process.

In yet another example, a NUC process may be initiated by host device 102 if a minimum time has elapsed since a previously performed NUC process. In a further example, a NUC process may be initiated by host device 102 if infrared imaging module 100 has experienced a minimum temperature change since a previously performed NUC process. In a still further example, a NUC process may be continuously initiated and repeated.

In block 515, after a NUC process initiating event is detected, it is determined whether the NUC process should actually be performed. In this regard, the NUC process may be selectively initiated based on whether one or more additional conditions are met. For example, in one embodiment, the NUC process may not be performed unless a minimum time has elapsed since a previously performed NUC process. In another embodiment, the NUC process may not be performed unless infrared imaging module 100 has experienced a minimum temperature change since a previously performed NUC process. Other criteria or conditions may be used in other embodiments. If appropriate criteria or conditions have been met, then the flow diagram continues to block 520. Otherwise, the flow diagram returns to block 505.

In the NUC process, blurred image frames may be used to determine NUC terms which may be applied to captured image frames to correct for FPN. As discussed, in one embodiment, the blurred image frames may be obtained by accumulating multiple image frames of a moving scene (e.g., captured while the scene and/or the thermal imager is in motion). In another embodiment, the blurred image frames may be obtained by defocusing an optical element or other component of the thermal imager.

Accordingly, in block 520 a choice of either approach is provided. If the motion-based approach is used, then the flow diagram continues to block 525. If the defocus-based approach is used, then the flow diagram continues to block 530.

Referring now to the motion-based approach, in block 525 motion is detected. For example, in one embodiment, motion may be detected based on the image frames captured by infrared sensors 132. In this regard, an appropriate motion detection process (e.g., an image registration process, a frame-to-frame difference calculation, or other appropriate process) may be applied to captured image frames to determine whether motion is present (e.g., whether static or moving image frames have been captured). For example, in one embodiment, it can be determined whether pixels or regions around the pixels of consecutive image frames have changed more than a user defined amount (e.g., a percentage and/or threshold value). If at least a given percentage of pixels have changed by at least the user defined amount, then motion will be detected with sufficient certainty to proceed to block 535.

In another embodiment, motion may be determined on a per pixel basis, wherein only pixels that exhibit significant changes are accumulated to provide the blurred image frame. For example, counters may be provided for each pixel and used to ensure that the same number of pixel values are accumulated for each pixel, or used to average the pixel values based on the number of pixel values actually accumulated for each pixel. Other types of image-based motion detection may be performed such as performing a Radon transform.

In another embodiment, motion may be detected based on data provided by motion sensors 194. In one embodiment, such motion detection may include detecting whether host device 102 is moving along a relatively straight trajectory through space. For example, if host device 102 is moving along a relatively straight trajectory, then it is possible that certain objects appearing in the imaged scene may not be sufficiently blurred (e.g., objects in the scene that may be aligned with or moving substantially parallel to the straight trajectory). Thus, in such an embodiment, the motion detected by motion sensors 194 may be conditioned on host device 102 exhibiting, or not exhibiting, particular trajectories.

In yet another embodiment, both a motion detection process and motion sensors 194 may be used. Thus, using any of these various embodiments, a determination can be made as to whether or not each image frame was captured while at least a portion of the scene and host device 102 were in motion relative to each other (e.g., which may be caused by host device 102 moving relative to the scene, at least a portion of the scene moving relative to host device 102, or both).

It is expected that the image frames for which motion was detected may exhibit some secondary blurring of the captured scene (e.g., blurred thermal image data associated with the scene) due to the thermal time constants of infrared sensors 132 (e.g., microbolometer thermal time constants) interacting with the scene movement.

In block 535, image frames for which motion was detected are accumulated. For example, if motion is detected for a continuous series of image frames, then the image frames of the series may be accumulated. As another example, if motion is detected for only some image frames, then the non-moving image frames may be skipped and not included in the accumulation. Thus, a continuous or discontinuous set of image frames may be selected to be accumulated based on the detected motion.

In block 540, the accumulated image frames are averaged to provide a blurred image frame. Because the accumulated image frames were captured during motion, it is expected that actual scene information will vary between the image frames and thus cause the scene information to be further blurred in the resulting blurred image frame (block 545).

In contrast, FPN (e.g., caused by one or more components of infrared imaging module 100) will remain fixed over at least short periods of time and over at least limited changes in scene irradiance during motion. As a result, image frames captured in close proximity in time and space during motion will suffer from identical or at least very similar FPN. Thus, although scene information may change in consecutive image frames, the FPN will stay essentially constant. By averaging, multiple image frames captured during motion will blur the scene information, but will not blur the FPN. As a result, FPN will remain more clearly defined in the blurred image frame provided in block 545 than the scene information.

In one embodiment, 32 or more image frames are accumulated and averaged in blocks 535 and 540. However, any desired number of image frames may be used in other embodiments, but with generally decreasing correction accuracy as frame count is decreased.

Referring now to the defocus-based approach, in block 530, a defocus operation may be performed to intentionally defocus the image frames captured by infrared sensors 132. For example, in one embodiment, one or more actuators 199 may be used to adjust, move, or otherwise translate optical element 180, infrared sensor assembly 128, and/or other components of infrared imaging module 100 to cause infrared sensors 132 to capture a blurred (e.g., unfocused) image frame of the scene. Other non-actuator based techniques are also contemplated for intentionally defocusing infrared image frames such as, for example, manual (e.g., user-initiated) defocusing.

Although the scene may appear blurred in the image frame, FPN (e.g., caused by one or more components of infrared imaging module 100) will remain unaffected by the defocusing operation. As a result, a blurred image frame of the scene will be provided (block 545) with FPN remaining more clearly defined in the blurred image than the scene information.

In the above discussion, the defocus-based approach has been described with regard to a single captured image frame. In another embodiment, the defocus-based approach may include accumulating multiple image frames while the infrared imaging module 100 has been defocused and averaging the defocused image frames to remove the effects of temporal noise and provide a blurred image frame in block 545.

Thus, it will be appreciated that a blurred image frame may be provided in block 545 by either the motion-based approach or the defocus-based approach. Because much of the scene information will be blurred by either motion, defocusing, or both, the blurred image frame may be effectively considered a low pass filtered version of the original captured image frames with respect to scene information.

In block 550, the blurred image frame is processed to determine updated row and column FPN terms (e.g., if row and column FPN terms have not been previously determined then the updated row and column FPN terms may be new row and column FPN terms in the first iteration of block 550). As used in this disclosure, the terms row and column may be used interchangeably depending on the orientation of infrared sensors 132 and/or other components of infrared imaging module 100.

In one embodiment, block 550 includes determining a spatial FPN correction term for each row of the blurred image frame (e.g., each row may have its own spatial FPN correction term), and also determining a spatial FPN correction term for each column of the blurred image frame (e.g., each column may have its own spatial FPN correction term). Such processing may be used to reduce the spatial and slowly varying (1/f) row and column FPN inherent in thermal imagers caused by, for example, 1/f noise characteristics of amplifiers in ROTC 402 which may manifest as vertical and horizontal stripes in image frames.

Advantageously, by determining spatial row and column FPN terms using the blurred image frame, there will be a reduced risk of vertical and horizontal objects in the actual imaged scene from being mistaken for row and column noise (e.g., real scene content will be blurred while FPN remains unblurred).

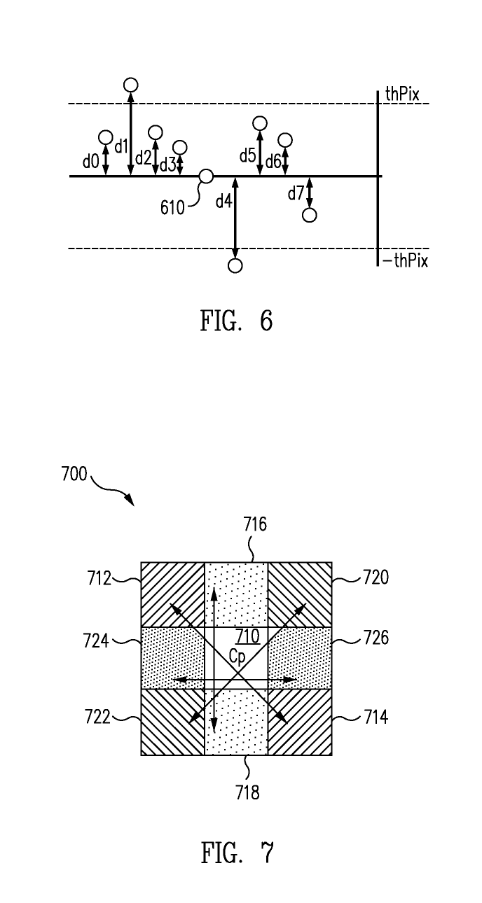

In one embodiment, row and column FPN terms may be determined by considering differences between neighboring pixels of the blurred image frame. For example, FIG. 6 illustrates differences between neighboring pixels in accordance with an embodiment of the disclosure. Specifically, in FIG. 6 a pixel 610 is compared to its 8 nearest horizontal neighbors: d0-d3 on one side and d4-d7 on the other side. Differences between the neighbor pixels can be averaged to obtain an estimate of the offset error of the illustrated group of pixels. An offset error may be calculated for each pixel in a row or column and the average result may be used to correct the entire row or column.

To prevent real scene data from being interpreted as noise, upper and lower threshold values may be used (thPix and −thPix). Pixel values falling outside these threshold values (pixels d1 and d4 in this example) are not used to obtain the offset error. In addition, the maximum amount of row and column FPN correction may be limited by these threshold values.

Further techniques for performing spatial row and column FPN correction processing are set forth in U.S. patent application Ser. No. 12/396,340 filed Mar. 2, 2009 which is incorporated herein by reference in its entirety.

Referring again to FIG. 5, the updated row and column FPN terms determined in block 550 are stored (block 552) and applied (block 555) to the blurred image frame provided in block 545. After these terms are applied, some of the spatial row and column FPN in the blurred image frame may be reduced. However, because such terms are applied generally to rows and columns, additional FPN may remain such as spatially uncorrelated FPN associated with pixel to pixel drift or other causes. Neighborhoods of spatially correlated FPN may also remain which may not be directly associated with individual rows and columns. Accordingly, further processing may be performed as discussed below to determine NUC terms.

In block 560, local contrast values (e.g., edges or absolute values of gradients between adjacent or small groups of pixels) in the blurred image frame are determined. If scene information in the blurred image frame includes contrasting areas that have not been significantly blurred (e.g., high contrast edges in the original scene data), then such features may be identified by a contrast determination process in block 560.

For example, local contrast values in the blurred image frame may be calculated, or any other desired type of edge detection process may be applied to identity certain pixels in the blurred image as being part of an area of local contrast. Pixels that are marked in this manner may be considered as containing excessive high spatial frequency scene information that would be interpreted as FPN (e.g., such regions may correspond to portions of the scene that have not been sufficiently blurred). As such, these pixels may be excluded from being used in the further determination of NUC terms. In one embodiment, such contrast detection processing may rely on a threshold that is higher than the expected contrast value associated with FPN (e.g., pixels exhibiting a contrast value higher than the threshold may be considered to be scene information, and those lower than the threshold may be considered to be exhibiting FPN).

In one embodiment, the contrast determination of block 560 may be performed on the blurred image frame after row and column FPN terms have been applied to the blurred image frame (e.g., as shown in FIG. 5). In another embodiment, block 560 may be performed prior to block 550 to determine contrast before row and column FPN terms are determined (e.g., to prevent scene based contrast from contributing to the determination of such terms).

Following block 560, it is expected that any high spatial frequency content remaining in the blurred image frame may be generally attributed to spatially uncorrelated FPN. In this regard, following block 560, much of the other noise or actual desired scene based information has been removed or excluded from the blurred image frame due to: intentional blurring of the image frame (e.g., by motion or defocusing in blocks 520 through 545), application of row and column FPN terms (block 555), and contrast determination (block 560).

Thus, it can be expected that following block 560, any remaining high spatial frequency content (e.g., exhibited as areas of contrast or differences in the blurred image frame) may be attributed to spatially uncorrelated FPN. Accordingly, in block 565, the blurred image frame is high pass filtered. In one embodiment, this may include applying a high pass filter to extract the high spatial frequency content from the blurred image frame. In another embodiment, this may include applying a low pass filter to the blurred image frame and taking a difference between the low pass filtered image frame and the unfiltered blurred image frame to obtain the high spatial frequency content. In accordance with various embodiments of the present disclosure, a high pass filter may be implemented by calculating a mean difference between a sensor signal (e.g., a pixel value) and its neighbors.

In block 570, a flat field correction process is performed on the high pass filtered blurred image frame to determine updated NUC terms (e.g., if a NUC process has not previously been performed then the updated NUC terms may be new NUC terms in the first iteration of block 570).

For example, FIG. 7 illustrates a flat field correction technique 700 in accordance with an embodiment of the disclosure. In FIG. 7, a NUC term may be determined for each pixel 710 of the blurred image frame using the values of its neighboring pixels 712 to 726. For each pixel 710, several gradients may be determined based on the absolute difference between the values of various adjacent pixels. For example, absolute value differences may be determined between: pixels 712 and 714 (a left to right diagonal gradient), pixels 716 and 718 (a top to bottom vertical gradient), pixels 720 and 722 (a right to left diagonal gradient), and pixels 724 and 726 (a left to right horizontal gradient).

These absolute differences may be summed to provide a summed gradient for pixel 710. A weight value may be determined for pixel 710 that is inversely proportional to the summed gradient. This process may be performed for all pixels 710 of the blurred image frame until a weight value is provided for each pixel 710. For areas with low gradients (e.g., areas that are blurry or have low contrast), the weight value will be close to one. Conversely, for areas with high gradients, the weight value will be zero or close to zero. The update to the NUC term as estimated by the high pass filter is multiplied with the weight value.

In one embodiment, the risk of introducing scene information into the NUC terms can be further reduced by applying some amount of temporal damping to the NUC term determination process. For example, a temporal damping factor λ between 0 and 1 may be chosen such that the new NUC term (NUC_{NEW}) stored is a weighted average of the old NUC term (NUC_{OLD}) and the estimated updated NUC term (NUC_{UPDATE}). In one embodiment, this can be expressed as NUC_{NEW}=λ·NUC_{OLD}+(1−λ)·(NUC_{OLD}+NUC_{UPDATE}).

Although the determination of NUC terms has been described with regard to gradients, local contrast values may be used instead where appropriate. Other techniques may also be used such as, for example, standard deviation calculations. Other types flat field correction processes may be performed to determine NUC terms including, for example, various processes identified in U.S. Pat. No. 6,028,309 issued Feb. 22, 2000, U.S. Pat. No. 6,812,465 issued Nov. 2, 2004, and U.S. patent application Ser. No. 12/114,865 fi led May 5, 2008, which are incorporated herein by reference in their entirety.

Referring again to FIG. 5, block 570 may include additional processing of the NUC terms. For example, in one embodiment, to preserve the scene signal mean, the sum of all NUC terms may be normalized to zero by subtracting the NUC term mean from each NUC term. Also in block 570, to avoid row and column noise from affecting the NUC terms, the mean value of each row and column may be subtracted from the NUC terms for each row and column. As a result, row and column FPN filters using the row and column FPN terms determined in block 550 may be better able to filter out row and column noise in further iterations (e.g., as further shown in FIG. 8) after the NUC terms are applied to captured images (e.g., in block 580 further discussed herein). In this regard, the row and column FPN filters may in general use more data to calculate the per row and per column offset coefficients (e.g., row and column FPN terms) and may thus provide a more robust alternative for reducing spatially correlated FPN than the NUC terms which are based on high pass filtering to capture spatially uncorrelated noise.

In blocks 571-573, additional high pass filtering and further determinations of updated NUC terms may be optionally performed to remove spatially correlated FPN with lower spatial frequency than previously removed by row and column FPN terms. In this regard, some variability in infrared sensors 132 or other components of infrared imaging module 100 may result in spatially correlated FPN noise that cannot be easily modeled as row or column noise. Such spatially correlated FPN may include, for example, window defects on a sensor package or a cluster of infrared sensors 132 that respond differently to irradiance than neighboring infrared sensors 132. In one embodiment, such spatially correlated FPN may be mitigated with an offset correction. If the amount of such spatially correlated FPN is significant, then the noise may also be detectable in the blurred image frame. Since this type of noise may affect a neighborhood of pixels, a high pass filter with a small kernel may not detect the FPN in the neighborhood (e.g., all values used in high pass filter may be taken from the neighborhood of affected pixels and thus may be affected by the same offset error). For example, if the high pass filtering of block 565 is performed with a small kernel (e.g., considering only immediately adjacent pixels that fall within a neighborhood of pixels affected by spatially correlated FPN), then broadly distributed spatially correlated FPN may not be detected.

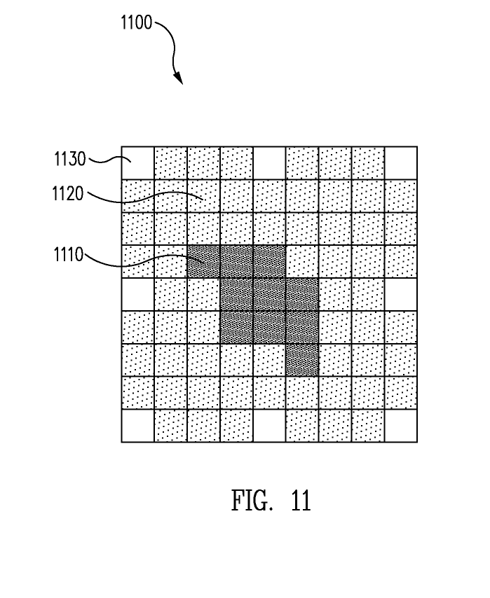

For example, FIG. 11 illustrates spatially correlated FPN in a neighborhood of pixels in accordance with an embodiment of the disclosure. As shown in a sample image frame 1100, a neighborhood of pixels 1110 may exhibit spatially correlated FPN that is not precisely correlated to individual rows and columns and is distributed over a neighborhood of several pixels (e.g., a neighborhood of approximately 4 by 4 pixels in this example). Sample image frame 1100 also includes a set of pixels 1120 exhibiting substantially uniform response that are not used in filtering calculations, and a set of pixels 1130 that are used to estimate a low pass value for the neighborhood of pixels 1110. In one embodiment, pixels 1130 may be a number of pixels divisible by two in order to facilitate efficient hardware or software calculations.

Referring again to FIG. 5, in blocks 571-573, additional high pass filtering and further determinations of updated NUC terms may be optionally performed to remove spatially correlated FPN such as exhibited by pixels 1110. In block 571, the updated NUC terms determined in block 570 are applied to the blurred image frame. Thus, at this time, the blurred image frame will have been initially corrected for spatially correlated FPN (e.g., by application of the updated row and column FPN terms in block 555), and also initially corrected for spatially uncorrelated FPN (e.g., by application of the updated NUC terms applied in block 571).

In block 572, a further high pass filter is applied with a larger kernel than was used in block 565, and further updated NUC terms may be determined in block 573. For example, to detect the spatially correlated FPN present in pixels 1110, the high pass filter applied in block 572 may include data from a sufficiently large enough neighborhood of pixels such that differences can be determined between unaffected pixels (e.g., pixels 1120) and affected pixels (e.g., pixels 1110). For example, a low pass filter with a large kernel can be used (e.g., an N by N kernel that is much greater than 3 by 3 pixels) and the results may be subtracted to perform appropriate high pass filtering.

In one embodiment, for computational efficiency, a sparse kernel may be used such that only a small number of neighboring pixels inside an N by N neighborhood are used. For any given high pass filter operation using distant neighbors (e.g., a large kernel), there is a risk of modeling actual (potentially blurred) scene information as spatially correlated FPN. Accordingly, in one embodiment, the temporal damping factor λ, may be set close to 1 for updated NUC terms determined in block 573.

In various embodiments, blocks 571-573 may be repeated (e.g., cascaded) to iteratively perform high pass filtering with increasing kernel sizes to provide further updated NUC terms further correct for spatially correlated FPN of desired neighborhood sizes. In one embodiment, the decision to perform such iterations may be determined by whether spatially correlated FPN has actually been removed by the updated NUC terms of the previous performance of blocks 571-573.

After blocks 571-573 are finished, a decision is made regarding whether to apply the updated NUC terms to captured image frames (block 574). For example, if an average of the absolute value of the NUC terms for the entire image frame is less than a minimum threshold value, or greater than a maximum threshold value, the NUC terms may be deemed spurious or unlikely to provide meaningful correction. Alternatively, thresholding criteria may be applied to individual pixels to determine which pixels receive updated NUC terms. In one embodiment, the threshold values may correspond to differences between the newly calculated NUC terms and previously calculated NUC terms. In another embodiment, the threshold values may be independent of previously calculated NUC terms. Other tests may be applied (e.g., spatial correlation tests) to determine whether the NUC terms should be applied.

If the NUC terms are deemed spurious or unlikely to provide meaningful correction, then the flow diagram returns to block 505. Otherwise, the newly determined NUC terms are stored (block 575) to replace previous NUC terms (e.g., determined by a previously performed iteration of FIG. 5) and applied (block 580) to captured image frames.

FIG. 8 illustrates various image processing techniques of FIG. 5 and other operations applied in an image processing pipeline 800 in accordance with an embodiment of the disclosure. In this regard, pipeline 800 identifies various operations of FIG. 5 in the context of an overall iterative image processing scheme for correcting image frames provided by infrared imaging module 100. In some embodiments, pipeline 800 may be provided by processing module 160 or processor 195 (both also generally referred to as a processor) operating on image frames captured by infrared sensors 132.

Image frames captured by infrared sensors 132 may be provided to a frame averager 804 that integrates multiple image frames to provide image frames 802 with an improved signal to noise ratio. Frame averager 804 may be effectively provided by infrared sensors 132, ROIC 402, and other components of infrared sensor assembly 128 that are implemented to support high image capture rates. For example, in one embodiment, infrared sensor assembly 128 may capture infrared image frames at a frame rate of 240 Hz (e.g., 240 images per second). In this embodiment, such a high frame rate may be implemented, for example, by operating infrared sensor assembly 128 at relatively low voltages (e.g., compatible with mobile telephone voltages) and by using a relatively small array of infrared sensors 132 (e.g., an array of 64 by 64 infrared sensors in one embodiment).

In one embodiment, such infrared image frames may be provided from infrared sensor assembly 128 to processing module 160 at a high frame rate (e.g., 240 Hz or other frame rates). In another embodiment, infrared sensor assembly 128 may integrate over longer time periods, or multiple time periods, to provide integrated (e.g., averaged) infrared image frames to processing module 160 at a lower frame rate (e.g., 30 Hz, 9 Hz, or other frame rates). Further information regarding implementations that may be used to provide high image capture rates may be found in U.S. Provisional Patent Application No. 61/495,879 previously referenced herein.

Image frames 802 proceed through pipeline 800 where they are adjusted by various terms, temporally filtered, used to determine the various adjustment terms, and gain compensated.

In blocks 810 and 814, factory gain terms 812 and factory offset terms 816 are applied to image frames 802 to compensate for gain and offset differences, respectively, between the various infrared sensors 132 and/or other components of infrared imaging module 100 determined during manufacturing and testing.

In block 580, NUC terms 817 are applied to image frames 802 to correct for FPN as discussed. In one embodiment, if NUC terms 817 have not yet been determined (e.g., before a NUC process has been initiated), then block 580 may not be performed or initialization values may be used for NUC terms 817 that result in no alteration to the image data (e.g., offsets for every pixel would be equal to zero).

In blocks 818 and 822, column FPN terms 820 and row FPN terms 824, respectively, are applied to image frames 802. Column FPN terms 820 and row FPN terms 824 may be determined in accordance with block 550 as discussed. In one embodiment, if the column FPN terms 820 and row FPN terms 824 have not yet been determined (e.g., before a NUC process has been initiated), then blocks 818 and 822 may not be performed or initialization values may be used for the column FPN terms 820 and row FPN terms 824 that result in no alteration to the image data (e.g., offsets for every pixel would be equal to zero).

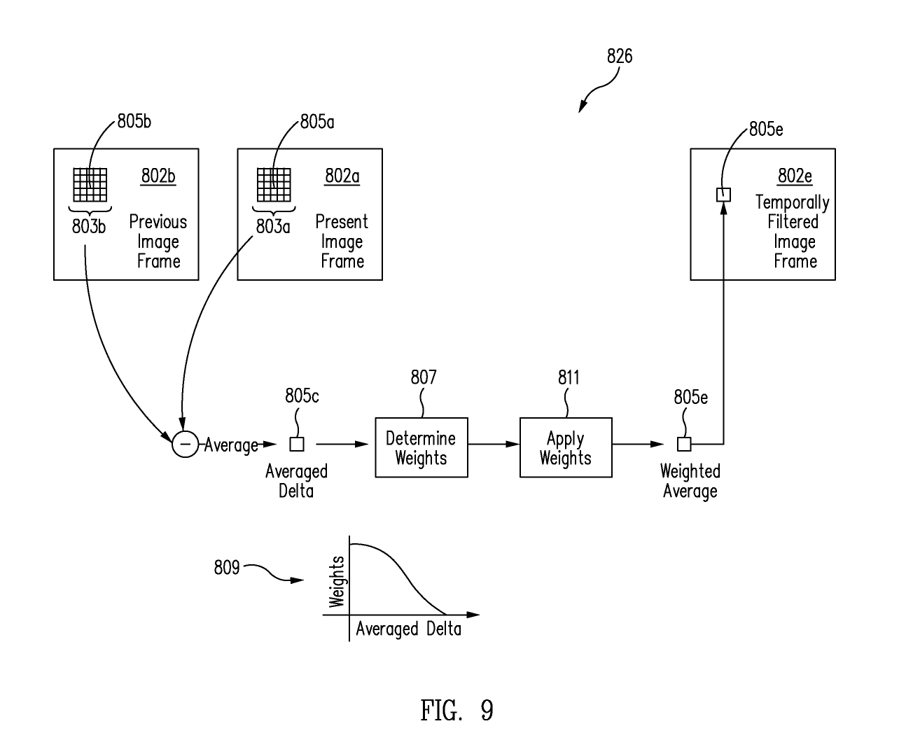

In block 826, temporal filtering is performed on image frames 802 in accordance with a temporal noise reduction (TNR) process. FIG. 9 illustrates a TNR process in accordance with an embodiment of the disclosure. In FIG. 9, a presently received image frame 802a and a previously temporally filtered image frame 802b are processed to determine a new temporally filtered image frame 802e. Image frames 802a and 802b include local neighborhoods of pixels 803a and 803b centered around pixels 805a and 805b, respectively. Neighborhoods 803a and 803b correspond to the same locations within image frames 802a and 802b and are subsets of the total pixels in image frames 802a and 802b. In the illustrated embodiment, neighborhoods 803a and 803b include areas of 5 by 5 pixels. Other neighborhood sizes may be used in other embodiments.

Differences between corresponding pixels of neighborhoods 803a and 803b are determined and averaged to provide an averaged delta value 805c for the location corresponding to pixels 805a and 805b. Averaged delta value 805c may be used to determine weight values in block 807 to be applied to pixels 805a and 805b of image frames 802a and 802b.

In one embodiment, as shown in graph 809, the weight values determined in block 807 may be inversely proportional to averaged delta value 805c such that weight values drop rapidly towards zero when there are large differences between neighborhoods 803a and 803b. In this regard, large differences between neighborhoods 803a and 803b may indicate that changes have occurred within the scene (e.g., due to motion) and pixels 802a and 802b may be appropriately weighted, in one embodiment, to avoid introducing blur across frame-to-frame scene changes. Other associations between weight values and averaged delta value 805c may be used in various embodiments.

The weight values determined in block 807 may be applied to pixels 805a and 805b to determine a value for corresponding pixel 805e of image frame 802e (block 811). In this regard, pixel 805e may have a value that is a weighted average (or other combination) of pixels 805a and 805b, depending on averaged delta value 805c and the weight values determined in block 807.

For example, pixel 805e of temporally filtered image frame 802e may be a weighted sum of pixels 805a and 805b of image frames 802a and 802b. If the average difference between pixels 805a and 805b is due to noise, then it may be expected that the average change between neighborhoods 805a and 805b will be close to zero (e.g., corresponding to the average of uncorrelated changes). Under such circumstances, it may be expected that the sum of the differences between neighborhoods 805a and 805b will be close to zero. In this case, pixel 805a of image frame 802a may both be appropriately weighted so as to contribute to the value of pixel 805e.

However, if the sum of such differences is not zero (e.g., even differing from zero by a small amount in one embodiment), then the changes may be interpreted as being attributed to motion instead of noise. Thus, motion may be detected based on the average change exhibited by neighborhoods 805a and 805b. Under these circumstances, pixel 805a of image frame 802a may be weighted heavily, while pixel 805b of image frame 802b may be weighted lightly.

Other embodiments are also contemplated. For example, although averaged delta value 805c has been described as being determined based on neighborhoods 805a and 805b, in other embodiments averaged delta value 805c may be determined based on any desired criteria (e.g., based on individual pixels or other types of groups of sets of pixels).

In the above embodiments, image frame 802a has been described as a presently received image frame and image frame 802b has been described as a previously temporally filtered image frame. In another embodiment, image frames 802a and 802b may be first and second image frames captured by infrared imaging module 100 that have not been temporally filtered.

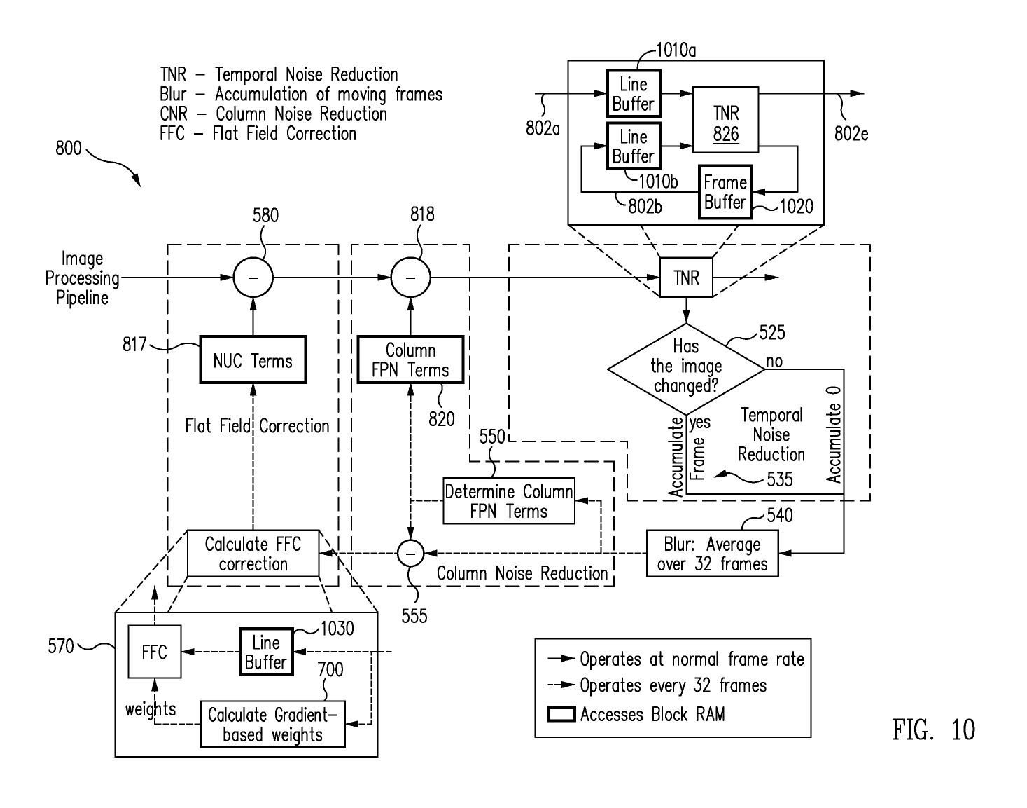

FIG. 10 illustrates further implementation details in relation to the TNR process of block 826. As shown in FIG. 10, image frames 802a and 802b may be read into line buffers 1010a and 1010b, respectively, and image frame 802b (e.g., the previous image frame) may be stored in a frame buffer 1020 before being read into line buffer 1010b. In one embodiment, line buffers 1010a-b and frame buffer 1020 may be implemented by a block of random access memory (RAM) provided by any appropriate component of infrared imaging module 100 and/or host device 102.

Referring again to FIG. 8, image frame 802e may be passed to an automatic gain compensation block 828 for further processing to provide a result image frame 830 that may be used by host device 102 as desired.

FIG. 8 further illustrates various operations that may be performed to determine row and column FPN terms and NUC terms as discussed. In one embodiment, these operations may use image frames 802e as shown in FIG. 8. Because image frames 802e have already been temporally filtered, at least some temporal noise may be removed and thus will not inadvertently affect the determination of row and column FPN terms 824 and 820 and NUC terms 817. In another embodiment, non-temporally filtered image frames 802 may be used.

In FIG. 8, blocks 510, 515, and 520 of FIG. 5 are collectively represented together. As discussed, a NUC process may be selectively initiated and performed in response to various NUC process initiating events and based on various criteria or conditions. As also discussed, the NUC process may be performed in accordance with a motion-based approach (blocks 525, 535, and 540) or a defocus-based approach (block 530) to provide a blurred image frame (block 545). FIG. 8 further illustrates various additional blocks 550, 552, 555, 560, 565, 570, 571, 572, 573, and 575 previously discussed with regard to FIG. 5.

As shown in FIG. 8, row and column FPN terms 824 and 820 and NUC terms 817 may be determined and applied in an iterative fashion such that updated terms are determined using image frames 802 to which previous terms have already been applied. As a result, the overall process of FIG. 8 may repeatedly update and apply such terms to continuously reduce the noise in image frames 830 to be used by host device 102.

Referring again to FIG. 10, further implementation details are illustrated for various blocks of FIGS. 5 and 8 in relation to pipeline 800. For example, blocks 525, 535, and 540 are shown as operating at the normal frame rate of image frames 802 received by pipeline 800. In the embodiment shown in FIG. 10, the determination made in block 525 is represented as a decision diamond used to determine whether a given image frame 802 has sufficiently changed such that it may be considered an image frame that will enhance the blur if added to other image frames and is therefore accumulated (block 535 is represented by an arrow in this embodiment) and averaged (block 540).

Also in FIG. 10, the determination of column FPN terms 820 (block 550) is shown as operating at an update rate that in this example is 1/32 of the sensor frame rate (e.g., normal frame rate) due to the averaging performed in block 540. Other update rates may be used in other embodiments. Although only column FPN terms 820 are identified in FIG. 10, row FPN terms 824 may be implemented in a similar fashion at the reduced frame rate.

FIG. 10 also illustrates further implementation details in relation to the NUC determination process of block 570. In this regard, the blurred image frame may be read to a line buffer 1030 (e.g., implemented by a block of RAM provided by any appropriate component of infrared imaging module 100 and/or host device 102). The flat field correction technique 700 of FIG. 7 may be performed on the blurred image frame.

In view of the present disclosure, it will be appreciated that techniques described herein may be used to remove various types of FPN (e.g., including very high amplitude FPN) such as spatially correlated row and column FPN and spatially uncorrelated FPN.

Other embodiments are also contemplated. For example, in one embodiment, the rate at which row and column FPN terms and/or NUC terms are updated can be inversely proportional to the estimated amount of blur in the blurred image frame and/or inversely proportional to the magnitude of local contrast values (e.g., determined in block 560).

In various embodiments, the described techniques may provide advantages over conventional shutter-based noise correction techniques. For example, by using a shutterless process, a shutter (e.g., such as shutter 105) need not be provided, thus permitting reductions in size, weight, cost, and mechanical complexity. Power and maximum voltage supplied to, or generated by, infrared imaging module 100 may also be reduced if a shutter does not need to be mechanically operated. Reliability will be improved by removing the shutter as a potential point of failure. A shutterless process also eliminates potential image interruption caused by the temporary blockage of the imaged scene by a shutter.

Also, by correcting for noise using intentionally blurred image frames captured from a real world scene (not a uniform scene provided by a shutter), noise correction may be performed on image frames that have irradiance levels similar to those of the actual scene desired to be imaged. This can improve the accuracy and effectiveness of noise correction terms determined in accordance with the various described techniques.

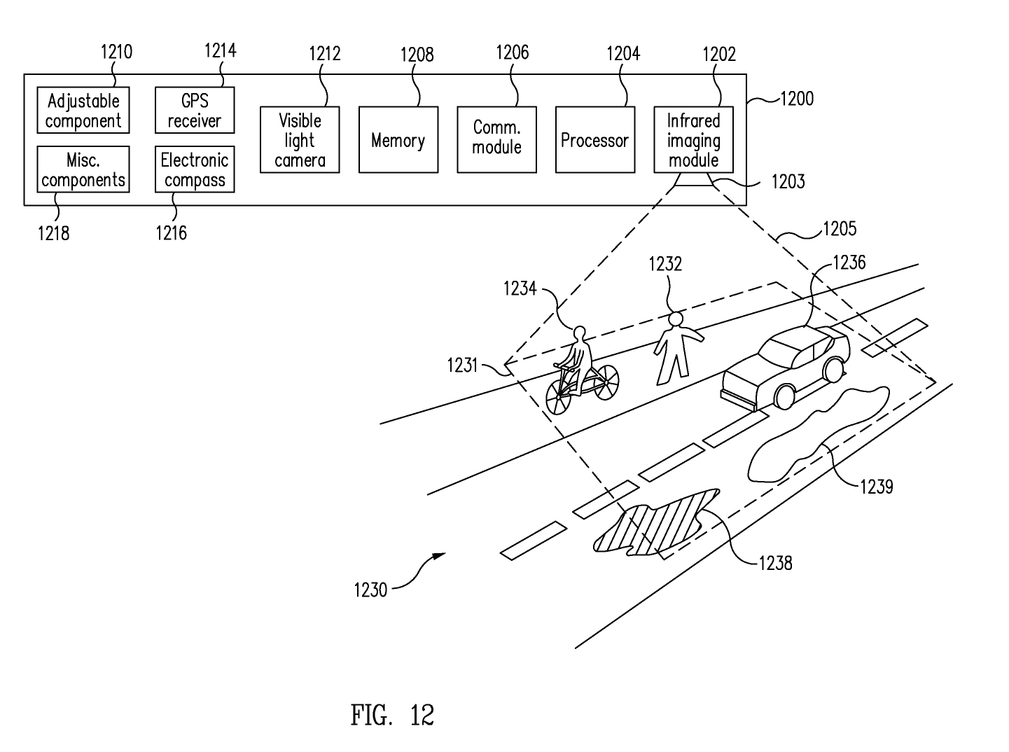

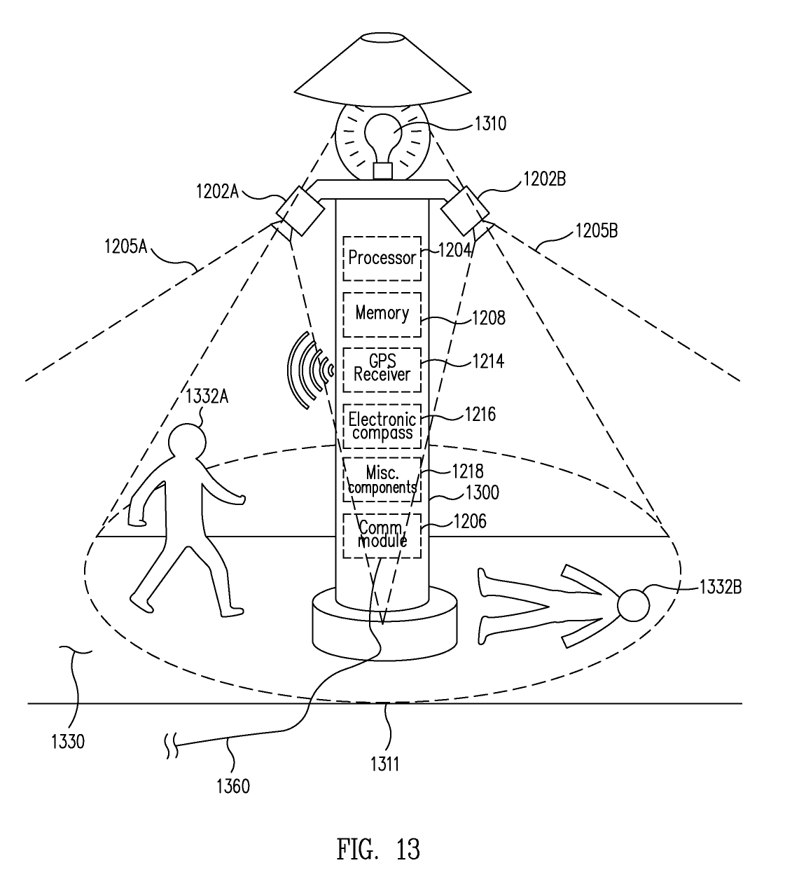

Referring now to FIG. 12, a block diagram is shown of a system 1200 using an infrared imaging module 1202 for intelligent monitoring of a thoroughfares 1230 in accordance with an embodiment of the disclosure. Thoroughfare 1230 may be, for example, a street, a roadway, a highway, a passage of a tunnel, a railway, a track, a pike, a trail, a pavement, a pathway, a footpath, a pedestrian passage, a walkway, a sidewalk, or any combination thereof, which may be traveled on or otherwise occupied by people (e.g., a pedestrian 1232, a cyclist 1234), animals, and/or vehicles (e.g., vehicle 1236).

System 1200 may include infrared imaging module 1202, a processor 1204, a communication module 1206, a memory 1208, an adjustable component 1210, a visible light camera 1212, a global positioning system (GPS) receiver 1214, an electronic compass 1216 and/or miscellaneous components 1218. In various embodiments, components of system 1200 may be implemented in the same or similar manner as corresponding components of host device 102 of FIG. 1. Moreover, components of system 1200 may be configured to perform various NUC processes and other processes described herein.

In some embodiments, infrared imaging module 1202 may be a small form factor infrared camera or a small form factor infrared imaging device implemented in accordance with various embodiments disclosed herein. Infrared imaging module 1202 may include an FPA implemented, for example, in accordance with various embodiments disclosed herein or others where appropriate.

Infrared imaging module 1202 may be configured to capture, process, and/or otherwise manage infrared images (e.g., including thermal images) of a scene 1231 that comprises at least a portion of one or more thoroughfares 1230. In this regard, infrared imaging module 1202 may be attached, mounted, installed, or otherwise disposed at a location on a structure or an installation along thoroughfare 1230, so that the desired portion of thoroughfare 1230 is placed within scene 1231 defined by a field of view (FOV) 1205 of infrared imaging module 1202. For example, infrared imaging module 1202 may be installed at a street light, a traffic light, a road sign, a street sign, a wall of a building, an inner wall of a tunnel, or other suitable installations and structures that are present on or near thoroughfare 1230. Infrared imaging module 1202 may also be installed at a pole, a post, or any other suitable structure that is provided specifically for attaching or mounting of infrared imaging module 1202.

In various embodiments, all or some of the other components of system 1200 may be co-located with infrared imaging module 1202. That is, all or some of the other components may also be attached, mounted, installed or otherwise disposed at a structure or an installation along with infrared imaging module 1202. For example, FIG. 13 shows components of system 1200 installed in a street light 1300 in accordance with an embodiment of the disclosure.

As shown in this example, adjustable component 1210 of system 1200 may be a light source 1310 of street light 1300. Light source 1310 may be implemented with any light bulb or light emitting device, preferably having a short response time to output adjustments. By way of non-limiting example, light source 1310 may be implemented with one or more light-emitting diodes (LEDs). As generally known, LED-based bulbs can be turned on, off, dimmed, or brightened with little to no delay. Other types of light emitting devices that may implement light source 1310 include, but are not limited to, incandescent lamps, electroluminescent lamps, fluorescent lamps, and electrodeless lamps.

The output of light source 1310 may be adjusted (e.g., turned on, turned off, or dimmed to any level) by a control signal generated, for example, by processor 1204. When turned on, light source 1310 may illuminate a portion of thoroughfare 1230/1330 that substantially defines an illumination area 1311 of street light 1300. Thus, for example, processor 1204 may generate a control signal to turn on or increase output of light source 1310 when it is determined that a pedestrian 1332A is or will be within illumination area 1311, as further described herein.

In one embodiment, light source 1310 may be implemented with one or more light sources (e.g., LEDs and/or other types of light sources) to selectively change the color of light emitted therefrom (e.g., white, red, orange, yellow, green, blue, and/or other visible light colors and/or non-visible light such as infrared or other wavelengths). For example, light source 1310 may include a multi-color light source provided, for example, in a casing (e.g., a housing or shared enclosure). In another example, light source 1310 may include a plurality of separate discrete light sources. In yet another example, light source 1310 may include a selectable set of filters (e.g., implemented by a motorized color filter wheel or otherwise) used to selectively pass, absorb, or block various wavelengths. Other appropriate implementations are also contemplated.

In various embodiments, light source 1310 and any associated filter implementation may be implemented with appropriate circuitry to selectively turning on appropriate emitters for one or multiple colors, and/or selective operate appropriate filters, in response to one or more control signals (e.g., control signals received from processor 1204).

Thus, for example, processor 1204 may generate a control signal to change the output color of light source 1310 in response to various alarms described herein, to alert persons on or near thoroughfares (e.g., pedestrians, drivers) of various conditions and events. For example, the output color of light source 1310 may turn red if there is a vehicle accident or a person in need of help, turn orange if hazardous road surface conditions (e.g., icy road, wet road) exists, or turn into other desired colors to warn of other conditions and events. In some embodiments, light source 1310 may be further configured to alternate among a plurality of colors or flicker on and off, so that the alerts conveyed via colored light may be more noticeable, for example.

As also shown in FIG. 13, in various embodiments, system 1200 may comprise a plurality of infrared imaging modules 1202A-1202B implemented in the same or similar manner as infrared imaging module 1202, and having FOVs 1205A-1205B. Utilizing a plurality of infrared imaging modules (e.g., infrared imaging modules 1202A-1202B) may permit monitoring of a larger portion of thoroughfare 1230/1330 than what can be covered by one infrared imaging module.

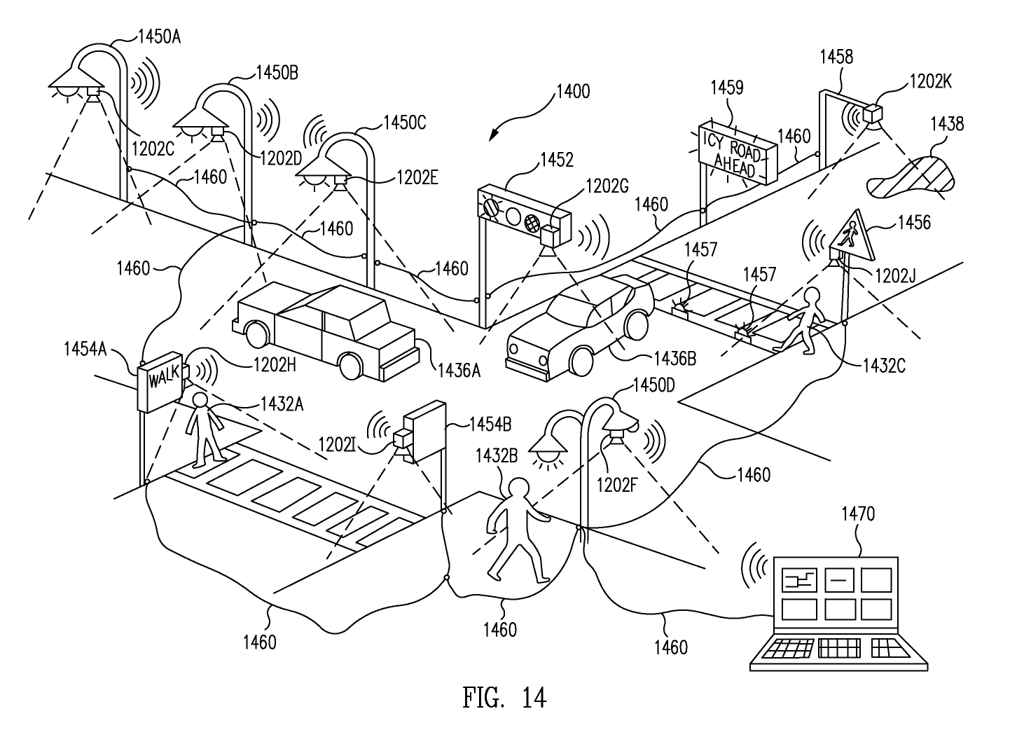

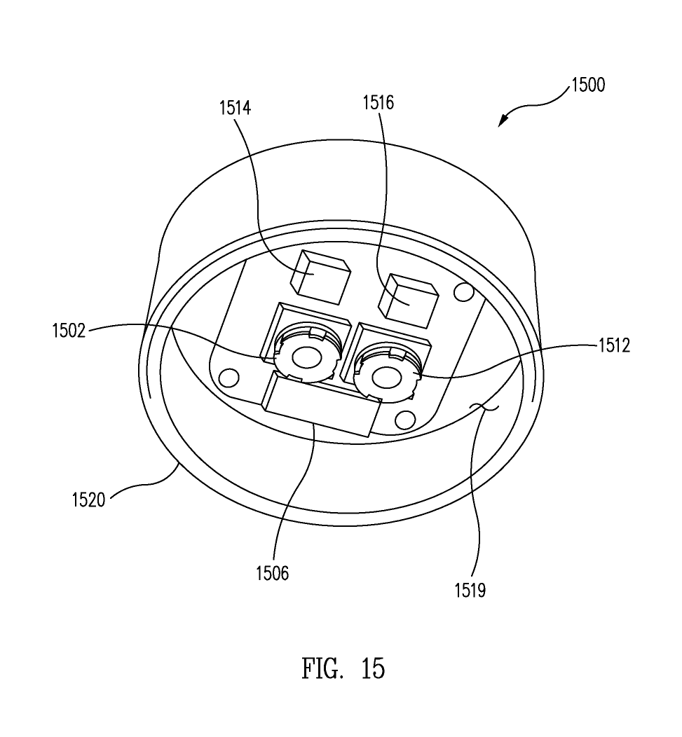

In this vein, a plurality of infrared imaging modules may be installed at a plurality of locations distributed along one or more thoroughfares to monitor thoroughfares that extend over a wider area, for example, from a stretch of street or a city block to an entire city or even larger areas. For example, FIG. 14 shows a plurality of infrared imaging modules 1202C-1202K, any one of which may be implemented in the same or similar manner as infrared imaging module 1202, installed at a plurality of locations provided on a plurality of installations or structures, such as various street lights 1450A-1450D, a traffic light 1452, pedestrian crossing lights 1454A-1454B, a road sign 1456, and a camera post 1458, distributed throughout thoroughfares 1400 in accordance with an embodiment of the disclosure.

In one embodiment, each one of the plurality of infrared imaging modules (e.g., infrared imaging modules 1202C-1202K) may be co-located with all of the other components of system 1200. In other words, in one embodiment, a plurality of systems 1200 may be attached, mounted, or otherwise installed at a plurality of installations or structures (e.g., various street lights 1450A-1450D, traffic light 1452, pedestrian crossing lights 1454A-1454B, road sign 1456, and/or camera post 1458) distributed throughout one or more thoroughfares (e.g., thoroughfares 1400). For example, street lights 1450A-1450D may each be installed with an instance of system 1200 including all of its components.

Each one of the plurality of systems 1200 may be configured to communicate with one or more of other ones of the plurality of systems 1200, over a wired link 1460, a wireless link, or other appropriate network connections as further described herein with respect to communication module 1206. Also, at least one of the plurality of systems 1200 may be configured to communicate with a central monitoring station 1470 (e.g., implemented with one or more appropriate processing devices).

In another embodiment, one or more infrared imaging modules may be co-located with none or some but not all of the other components of system 1200. For example, infrared imaging module 1202H may be installed at pedestrian crossing light 1454A, but a corresponding processor, which may be an instance of processor 1204, may be located elsewhere such as at crossing light 1454B. In such a case and other appropriate situations, infrared imaging module 1202H may be configured to communicate with the corresponding processor located elsewhere over wired link 1460, a wireless link, or other appropriate network connections as further described herein with respect to communication module 1206.

Referring back to infrared imaging module 1202, in some embodiments infrared imaging module 1202 may include various optical elements 1203 (e.g., infrared-transmissive lens, infrared-transmissive prisms, infrared-reflective mirrors, infrared fiber optics) that guide infrared radiation from scene 1231 to an FPA of infrared imaging module 1202. Optical elements 1203 may be useful when it is difficult to mount infrared imaging module 1202 at a desired angle and/or location. For example, if there is little or no room for mounting infrared imaging module 1202 at a desired vantage point on a street sign, a flexible fiber-optic cable may be utilized to route infrared radiation collected at the vantage point to infrared imaging module 1202 mounted elsewhere. Note also that optical elements 1203 may be used to suitably define or alter FOV 1205 of infrared imaging module 1202. A switchable FOV (e.g., selectable by infrared imaging module 1202 and/or processor 1204) may optionally be provided, which may be useful, for example, when a selective close-up view of a portion of thoroughfare 1230/1330/1400 is desired.

Optical elements 1203 may also include one or more filters adapted to pass infrared radiation of certain wavelengths but substantially block off others (e.g., short-wave infrared (SWIR) filters, mid-wave infrared (MWIR) filters, long-wave infrared (LWIR) filters, and narrow-band filters). Such filters may be utilized to tailor infrared imaging module 1202 for increased sensitivity to a desired band of infrared wavelengths. For example, when detecting presence of ice and/or water as further described herein, a better result may be achieved by utilizing a narrow-band filter that transmits only in the wavelengths matching a specific absorption/emission spectrum of either ice, water, or both. In some embodiments, filters may be selectable (e.g., provided as a selectable filter wheel). In other embodiments, filters may be fixed as appropriate for a desired application of system 1200.

Infrared images captured, processed, and/or otherwise managed by infrared imaging module 1202 may be radiometrically normalized infrared images (e.g., thermal images). That is, pixels that make up the captured image may contain calibrated thermal data (e.g., temperature). As discussed above in connection with infrared imaging module 100 of FIG. 1, infrared imaging module 1202 and/or associated components may be calibrated using appropriate techniques so that images captured by infrared imaging module 1202 are properly calibrated thermal images. In some embodiments, appropriate calibration processes may be performed periodically by infrared imaging module 1202 and/or processor 1204 so that infrared imaging module 1202, and hence the thermal images captured by it, may maintain proper calibration.

Radiometric normalization permits infrared imaging module 1202 and/or processor 1204 to efficiently detect, from thermal images, objects having a specific range of temperature. Infrared imaging module 1202 and/or processor 1204 may detect such objects efficiently and effectively, because thermal images of objects having a specific temperature may be easily discernable from a background and other objects, and yet less susceptible to lighting conditions or obscuring.

For example, in one embodiment, infrared imaging module 1202 and/or processor 1204 may be configured to detect from thermal images contiguous regions of pixels (also referred to as “blobs” or “hot blobs”) having a temperature approximately in the range of a clothed person, for example, between approximately 75° F. (e.g., clothed part of a body) and approximately 110° F. (e.g., exposed part of a body such as a face and hands). Such “hot blobs” may indicate presence of persons in scene 1231, and may be analyzed further as described herein to ascertain the presence of one or more persons and determine various attributes associated with the detected persons. Infrared imaging module 1202 and/or processor 1204 may similarly detect and discern cars, motorcycles, buses, and trucks in scene 1231 by detecting and analyzing objects having a temperature in the range of operating motor vehicles. Thus, detection of motor vehicles and persons in scene 1231 by system 1200 may be efficient, yet less susceptible to false detection of spurious objects such as branches swinging in the wind.

Processor 1204 may be implemented as any appropriate processing device as described with regard to processor 195 in FIG. 1. Processor 1204 may be adapted to interface and communicate with other components of system 1200 to perform operations and processes described herein. Processor 1204 may be configured to receive thermal images of a scene (e.g., scene 1231) of a portion of thoroughfare 1230/1330/1400 captured by infrared imaging module 1202.

In one embodiment, processor 1204 may be configured to perform, on the received thermal images and the radiometric information contained therein, various thermal image processing and analysis operations to detect whether one or more objects (e.g., pedestrian 1232, cyclist 1234, vehicle 1236, or other persons or vehicles) are present on the portion of thoroughfare 1230/1330/1400 and determine one or more attributes associated with the detected objects. Processor 1204 may be configured to compile, analyze, or otherwise process the determined presence and attributes to generate monitoring information associated with the portion of thoroughfare 1230/1330/1400. In a non-limiting example, the monitoring information may identify whether one or more objects are present on the portion of thoroughfare 1230/1330/1400, what the type of the each detected object is (e.g., a person, an automobile, a truck, a bus, or other types of object that may be present on thoroughfare 1230/1330/1400), the count of the each detected type of object, the location of the each detected object, the motion vector (i.e., the direction and the speed of travel) of the each detected object, the time and duration of the detection of each object, and/or the posture (e.g., standing, sitting, lying down) if the detected object is a person.

In one embodiment, processor 1204 may be further configured to perform, on the received thermal images and the radiometric information contained therein, various thermal image processing and analysis operations as further described herein to determine the surface condition associated with the portion of thoroughfare 1230/1330/1400. For example, processor 1204 may be configured to determine presence of water (e.g., a wet road surface 1239), ice (e.g., an icy road surface 1238/1438), and/or snow on the surface of the portion of thoroughfare 1230/1330/1400. The monitoring information generated by processor 1204 may further identify the surface condition, thereby providing a real-time surface condition and weather monitoring of the portion of thoroughfare 1230/1330/1400.

In one embodiment, processor 1204 may be further configured to convert the thermal images into user-viewable images (e.g., thermograms) of the portion of thoroughfare 1230/1330/1400. For example, processor 1204 may convert the thermal data (e.g., temperature data) contained in the pixels of the thermal images into gray-scaled or color-scaled pixels to construct images that can be viewed by a person. User-viewable images may optionally include a legend or scale that indicates the approximate temperature of corresponding pixel color and/or intensity. Such user-viewable images may be viewed by a person associated with, for example, traffic management or law enforcement to better understand the monitoring information.

If visible light images of the portion of thoroughfare 1230/1330/1400 are available (e.g., captured by a visible light camera), processor 1204 may be further configured to fuse or combine the thermal images and the visible light images to generate user-viewable images having a higher definition and/or clarity. For example, processor 1204 may be configured to perform a resolution and contrast enhancing fusion operation disclosed in commonly assigned U.S. patent application Ser. No. 13/105,765, filed May 11, 2011, which is incorporated herein by reference in its entirety.

In various embodiments, processor 1204 may be further configured to take various actions based on the monitoring information. For example, in some embodiments, processor 1204 may be configured to generate various control signals to adjust operation of one or more adjustable components 1210 based on the monitoring information.

In one non-limiting example, adjustable component 1210 may be a light source of a street light (e.g., street light 1300), a sidewalk lamp, a security light, or of other similar lights and lamps for illuminating at least a portion of thoroughfare 1230/1330/1400 to aid a person on foot (e.g., pedestrian 1232/1332A), on a bicycle (e.g., cyclist 1234), in a vehicle (e.g., in vehicle 1236), or in any other way present or travelling on thoroughfare 1230/1330/1400. Processor 1204 may be configured to generate a control signal to selectively turn off, turn on, or adjust the output of such a light source (e.g., light source 1310) based on the monitoring information. By utilizing object types, object counts, positions, motion vectors, and/or other comprehensive and high-level monitoring information, processor 1204 may control the light source more accurately and intelligently than conventional automatic lighting controls. For example, processor 1204 may be configured to generate a control signal to increase the output of the light source in proportion to the number and the sizes of objects present, selectively turn on the light source for persons on foot or bicycles but not for vehicles, selectively turn on or off the light source based on the trajectory predicted by motion vectors, and/or control the light source in other intelligent manners.

In contrast, what conventional automatic lighting control systems using conventional sensors can do is typically limited to simply triggering the light source on or off when an object moves in or out of an area. Moreover, unlike the robust detection provided by thermal image and radiometric data analysis described herein, object detection by conventional sensors (e.g., passive infrared (PIR) motion detectors having some small number of pyroelectric cells, and active infrared rangefinders, ultrasonic sensors, microwave sensors, or other echo/transducer-type sensors) are often prone to false detection of spurious objects and sensitive to calibration.

In another non-limiting example, adjustable component 1210 may be a traffic light (e.g., traffic light 1452) or other similar lights and signals for indicating right of way or otherwise directing flow of traffic in thoroughfare 1230/1330/1400. Processor 1204 may generate a control signal to adjust operation of the traffic light, such as adjusting the timing of light changes, based on the monitoring information. In yet another non-limiting example, adjustable component 1210 may be a pedestrian and/or cyclist crosswalk signal, such as pedestrian crossing light 1454A/1454B or crosswalk warning lights 1457. For example, processor 1204 may generate a control signal to flash crosswalk warning lights 1457 if the monitoring information indicates a pedestrian 1432C is stepping off a curb, or generate a control signal to trigger a “walk” light on pedestrian crossing light 1454A/1454B if the monitoring information indicates a presence of a pedestrian 1432A waiting to cross. As discussed above, compared with detection information generated by conventional sensors, the monitoring information generated by processor 1204 may permit more accurate and more intelligent control of a traffic light or a pedestrian crossing light.

In some embodiments, processor 1204 may be configured to generate various alarms based on the monitoring information. In one non-limiting example, processor 1204 may generate an alarm if the monitoring information identifies a potentially dangerous road surface condition such as icy surface 1238/1438 or wet surface 1239. Various components of system 1200 may optionally be configured to present the alarm as colored light on street light 1300, a flashing road sign, as a message on a variable message panel 1459, or via any other suitable means for alerting drivers on thoroughfare 1230/1330/1400, for example, by generating and transmitting appropriate control signals to such warning signs or panels. Alternatively or additionally, processor 1204 and/or communication module 1206 may be configured to transmit the alarm to central monitoring station 1470, a traffic management system, a mobile device, a networked computer, or other external devices, so that appropriate alert may be presented on or by such devices.

In another non-limiting example, processor 1204 may be configured to determine whether a person detected in the thermal images may need assistance and generate an alarm based on the determination, by analyzing various attributes such as the posture of the person (e.g., whether the person is lying down), the location of the person, the body temperature of the person, the length of time the person has remained motionless, and/or other attributes determinable by processing and analyzing thermal images captured by infrared imaging module 1202. For example, processor 1204 may determine that a person 1332B who has been lying down on a sidewalk for more than a predetermined duration may need assistance, and generate an alarm in response. Processor 1204 and/or communication module 1206 may be configured to transmit the alarm to central monitoring station 1470, a traffic management system, a mobile device, a networked computer, or other external devices, so that the alarm may be conveyed to emergency responders or other appropriate entities that may be capable of assisting the person. Processor 1204 and/or communication module 1206 may also be configured to transmit a control signal to adjust the color output of street lights (e.g., street lights 1300/1450A-1450D) to alert other persons (e.g., rescue personnel, law enforcement personnel, pedestrians, drivers, cyclists) of an approximate location of the person in need of assistance. Other alarms, such as alarms to warn of a vehicle collision, a fire, a crowd gathering, or other events that may be determinable from the monitoring information, may also be generated.

In various embodiments, processor 1204 may be further configured to generate a control signal, generate an alarm, or take other actions based at least in part on monitoring information generated and transmitted by one or more other instances of system 1200 monitoring at least some other portions of thoroughfare 1230/1330/1400. For example, processor 1204 of system 1200 installed on street light 1450A of FIG. 14 may be configured to generate a control signal to adjust the operation of street light 1450A based at least in part on the monitoring information generated by another instance of system 1200 installed on street light 1450B, the monitoring information generated by yet another instance of system 1200 installed on street light 1450C, or both. Thus, for example, processor 1204 at street light 1450A may generate a control signal to turn on or increase output of a light source of street light 1450A in an anticipatory fashion, based at least in part on the monitoring information generated by another system 1200 at street light 1450C and indicating that a vehicle 1436A is moving in the direction of street light 1450A. Such anticipatory adjustment of street lights can beneficially create, for example, a corridor of lights opening up in the direction of travel, ahead of a vehicle or a pedestrian. The decision as to how many lights and/or how far ahead to turn on may be made intelligently based on, for example, the motion vector (i.e., the speed and direction of travel) of the detected object.

In another example, processor 1204 installed on pedestrian crossing light 1454A/1454B may adjust the triggering of a walk light based not only on its own monitoring information that identifies the presence and/or other attributes of pedestrian 1432A in the FOV of infrared imaging module 1202H, but also on monitoring information generated by another instance of system 1200 at traffic light 1452 and identifying the presence and the motion vector of vehicle 1436B in the FOV of infrared imaging module 1202G.

In this regard, communication module 1206 may be configured to facilitate communication among processors of a plurality of systems 1200 distributed at various locations along thoroughfare 1230/1330/1400. Communication module 1206 may include a network interface component (NIC) adapted for wired and/or wireless communication with a network and with other devices connected to the network. Through communication module 1206, processor 1204 may communicate with processors of other instances of system 1200, for example, to share monitoring information as described herein.

In various embodiments, communication module 1206 may include a wireless communication component (e.g., based on the IEEE 802.11 WiFi standards, the Bluetooth™ standard, the ZigBee™ standard, or other appropriate short range wireless communication standards), a wireless broadband component (e.g., based on WiMax technologies), mobile cellular component, a wireless satellite component, or other appropriate wireless communication components. Communication module 1206 may also be configured for a proprietary wireless communication protocol and interface based on radio frequency (RF), microwave frequency (MWF), infrared frequency (IRF), and/or other appropriate wireless transmission technologies. Communication module 1206 may include an antenna coupled thereto for wireless communication purposes.

In various embodiments, communication module 1206 may be configured to interface with a wired network via a wired communication component such as a power-line modem, a Digital Subscriber Line (DSL) modem, a Public Switched Telephone Network (PSTN) modem, an Ethernet interface, a cable modem, and/or other appropriate components for wired communication. Proprietary wired communication protocols and interfaces may also be supported by communication module 1206. Communication module 1206 may be configured to communicate over wired link 1360/1460 for wired communication purposes. For example, wired link 1360/1460 may be implemented with a power-line cable, a coaxial cable, a fiber-optics cable, or other appropriate cables or wires that support corresponding wired network technologies. In various embodiments, wired and/or wireless communication through communication module 1206 may utilize a network private to systems 1200, a public network, or both.

Communication module 1206 may be further configured to handle communication and interfacing between various components of system 1200. In some embodiments, components of system 1200 may interface and communicate with each other through a bus or other similar communication mechanisms. In other embodiments, components such as infrared imaging module 1202 and/or adjustable component 1210 may transmit and receive data to and from processor 1204 through communication module 1206, which may manage wired and/or wireless communication as described above. For example, a control signal generated by processor 1204 to adjust light source 1310 may be transmitted to control circuitry of light source 1310 through communication module 1206. In some embodiments, control circuitry of light source 1310, or of other instances of adjustable component 1210 such as a traffic light or a pedestrian crossing light, may be implemented in a central control panel, such as a street light control panel for a group of street lights in an area or a traffic control box commonly found at intersections for controlling traffic lights in an intersection. In such embodiments, communication module 1206 may be configured to appropriately route signals from processor 1204 or other components to a corresponding central control panel, and may be configured to interface with the central control panel using standardized control protocols such as National Transportation Communications for ITS Protocol (NTCIP) for traffic light control.

In some embodiments, system 1200 may comprise as many such communication modules 1206 as desired for various applications, installation, and/or configuration of system 1200 at various locations. In other embodiments, communication module 1206 may be integrated into or implemented as part of various other components of system 1200. For example, infrared imaging module 1202, processor 1204, and adjustable component 1210 may each comprise a subcomponent that may be configured to perform the operations of communication module 1206, and may communicate with one another via wired and/or wireless connection without separate communication module 1206.

In various embodiments, the monitoring information, the alarms, and/or the user-viewable images generated by processor 1204 may be transmitted to external devices and systems, such as central monitoring station 1470, a traffic management system, a mobile device (e.g., a smart phone), or a networked computer, through communication module 1206. Thus, for example, central monitoring station 1470, a traffic management system, or other networked computer systems may advantageously create a real-time city-wide map of traffic density (e.g., including vehicle, pedestrian, and/or cyclist traffic) or of where rain or snow is falling, by collecting, compiling, analyzing, or otherwise processing the monitoring information generated and transmitted by a plurality of systems 1200 distributed at various locations along thoroughfares 1230/1330/1400 extending throughout a city. Such high resolution traffic or weather maps may be beneficially provided through mobile device applications or web pages (e.g., to view using a mobile phone or an in-car navigation system), or may be used by a traffic management system to centrally coordinate traffic lights or other means of traffic control.

In another example, central monitoring station 1470, a traffic management system, or other networked computer systems may automatically update emergency evacuation routes based on hazards or accidents (e.g., a fire, a flood, a traffic accident) that may be identified in the monitoring information and/or the alarms, in addition to the traffic and road/weather condition. The automatically updated evacuation routes may be beneficially provided through mobile device applications or web pages.

In yet another example, central monitoring station 1470 or other networked computer systems may collect, compile, analyze, or otherwise process the monitoring information to create a detailed report of vehicle (e.g., including both moving and parked vehicles), pedestrian, and/or cyclist count and motion statistics. Such a report may beneficially support city planning activities.

In yet another example, emergency responders can have a mobile device that may be configured to receive the monitoring information and/or the user-viewable images from a plurality of systems 1200 in or near their path when driving in an emergency event.

Using the monitoring information and/or the user-viewable images, the mobile device may present to emergency responders a detailed indication of exactly where vehicles are in their path ahead, so that emergency responders can safely and promptly reach a site of emergency.

Memory 1208 may include one or more memory devices to store data and information, including the thermal images, the monitoring information, the alarms, and/or the user-viewable images generated by processor 1204. The one or more memory devices may include various types of memory for thermal image and other information storage including volatile and non-volatile memory devices, such as RAM (Random Access Memory), ROM (Read-Only Memory), EEPROM (Electrically-Erasable Read-Only Memory), flash memory, a disk drive. In some embodiments, processor 1204 may be configured to execute software instructions stored on memory 1208 to perform various methods, processes, or operations in the manner described herein.

In one or more embodiments, system 1200 may include a visible light camera 1212 for capturing visible light images of the portion of thoroughfare 1230/1330/1400. Visible light camera 1212 may be implemented with an appropriate imaging module having a visible light image sensor (e.g., CMOS-based or CCD-based sensor) and adapted for integration into small electronic devices (e.g., a camera module for mobile phones). The visible light images captured by visible light camera 1212 may be received by processor 1204 to fuse, superimpose, or otherwise combine with the thermal images as further described herein. In some embodiments, the visible light images may be received by processor 1204 to perform some supplemental detection operations (e.g., license plate recognition or other edge detection operations) that may benefit from higher definition images that can be provided by visible light camera 1212 in daytime. The visible light images may also be transmitted to external devices through communication module 1206.

In one or more embodiments, system 1200 may include GPS receiver 1214 and/or electronic compass 1216. GPS receiver 1214 and/or electronic compass 1216 may be implemented with an appropriate chipset or electronics module adapted for integration into small electronic devices to provide a GPS receiver function, an electronic compass function, or both. GPS receiver 1214 and/or the electronic compass 1216 may be utilized to automatically obtain geopositional information relating to the installed location of infrared imaging modules 1202/1202A-1202K. The geopositional information may be used by processor 1204 and/or communication module 1206 to automatically construct positional mapping information for location-aware communication among installed instances of system 1200, as further described herein.

Miscellaneous components 1218 may include any other device or sensor as may be desired for various applications of system 1200. For example, in various embodiments, miscellaneous components 1218 may include a warning light (e.g., a strobe light, a flashing light), a chime, a speaker with associated circuitry for generating a tone, or other appropriate devices that may be used to generate an audible and/or visible alert in response to the alarm generated by processor 1204. In another example, miscellaneous components 1218 may also include a temperature sensor (e.g., a thermocouple, a thermometer), a moisture sensor, and other sensors that may provide reference data points for calibrating or verifying the various thermal image analytics described herein. In another example, miscellaneous components 1218 may include appropriate light source control circuitry.

In various embodiments, one or more components of system 1200 may be combined and/or implemented or not, as desired or depending on application requirements. For example, processor 1204 may be combined with infrared imaging module 1202, memory 1208, and/or communication module 1206. In another example, processor 1204 may be combined with infrared imaging sensor 1202 with only certain operations of processor 1204 performed by circuitry (e.g., processor, logic device, microprocessor, microcontroller, etc.) within infrared imaging module 1202.

FIG. 15 shows an example of intelligent monitoring system 1200 implemented as an electronics module 1500 that can be readily incorporated into street lights (e.g., street light 1300) in accordance with an embodiment of the disclosure. Electronics module 1500 may include an infrared imaging module 1502, a visible light camera 1512, a GPS receiver 1514, an electronic compass 1516, a WiFi communication module 1506, light source control circuitry (e.g., provided by miscellaneous components 1218 in one embodiment), and a processor (e.g., provided by processor 1204 in one embodiment), any one of which may be implemented in the same or similar manner as the corresponding components of system 1200 described herein.

Electronics module 1500 may also include a housing 1520 that permits electronics module 1500 to be mounted, attached, retrofitted, or otherwise installed into conventional LED-based street lights, so that a wireless network (e.g., a wireless mesh network in some embodiments) of intelligent monitoring system 1200 may be quickly and conveniently deployed. Electronics module 1500 may also include a transparent cover 1519 disposed on housing 1520. Transparent cover 1519 may be configured to pass infrared and visible light through to infrared imaging module 1502 and visible light camera 1512, and may protect these and other components of electronics module 1500 from external elements (e.g., rain, debris).

In one embodiment, housing 1520 may be configured to orient electronics module 1500 when installed into a street light, such that infrared imaging module 1502 and/or visible light camera 1512 looks down on the surface of a thoroughfare, in a direction substantially parallel to the longitudinal length of the street light. In one embodiment, the area of the scene covered by infrared imaging module 1502 may be approximately 30 sq. ft. at the surface level of thoroughfares, when electronics module 1500 is installed at a typical street light.

Therefore, system 1200 or electronics module 1500 may be mounted, installed, or otherwise disposed at various locations along thoroughfares, to provide comprehensive monitoring of the thoroughfares. By capturing, processing, and analyzing thermal images of a scene that includes a desired portion of a thoroughfare, system 1200 or electronics module 1500 may determine a presence and various attributes of objects that may be present on the thoroughfare, and/or environmental conditions associated with the portion of the thoroughfare. Such comprehensive monitoring information may be beneficially utilized by system 1200 or electronics module 1500 in various situations including, but not limited to, adjusting operation of street lights, traffic lights, and/or sidewalk signals, and generating alarms if hazardous environmental conditions exist, an accident has occurred, or a person needs assistance. Such comprehensive monitoring information may be shared among multiple instances of system 1200 or electronics module 1500 distributed throughout thoroughfares, permitting a more intelligent coordination of various actions that may be taken by system 1200 or electronics module 1500. System 1200 or electronics module 1500 may also share or transmit such comprehensive monitoring information to external devices and systems, which may utilize the monitoring information to create a real-time map of traffic and/or environmental conditions, collect various statistics, or provide other beneficial information.

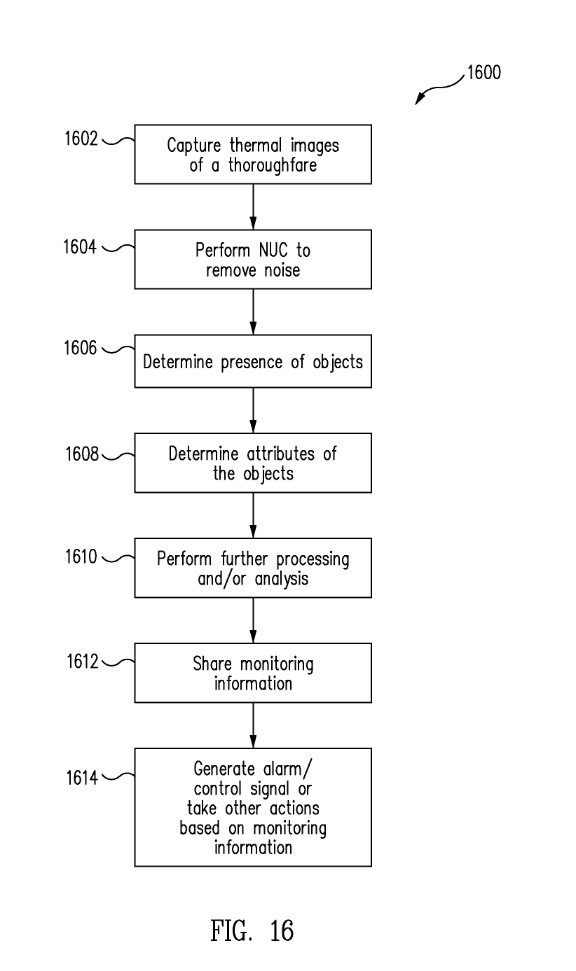

Referring now to FIG. 16, a flowchart is illustrated of a process 1600 for intelligent monitoring of thoroughfares using thermal imaging, in accordance with an embodiment of the disclosure. For example, process 1600 may be performed by system 1200 or electronics module 1500 installed at street lights 1300/1450A-1450D, traffic light 1452, pedestrian crossing lights 1454A-1454B, road sign 1456, or other suitable locations along thoroughfares. It should be appreciated that system 1200, electronics module 1500, and the various structures and installations are identified only for purposes of giving examples, and that any other suitable system may be mounted, attach, or otherwise installed at any other suitable location on or near thoroughfares to perform all or part of process 1600.

At block 1602, thermal images (e.g., containing pixels with radiometric data) of a scene comprising at least a portion of a thoroughfare may be captured by an infrared imaging module. For example, images of thermal radiation from scene 1231 within FOV 1205 may be captured by infrared imaging module 1202 of FIG. 12. The captured thermal images may be radiometrically calibrated thermal images as described above in connection with infrared imaging module 1202. Also, the captured thermal images may be scale and/or perspective calibrated thermal images. That is, geometric properties (e.g., size and position) of objects in the actual scene can be derived from the pixel coordinates of objects in the thermal images. Scale/perspective calibration may be performed manually or automatically using known techniques when infrared imaging module (e.g., infrared imaging module 1202A-1202B) is first installed at a desired location (e.g., at street light 1310). In some embodiments, automatic recalibration may also be performed using known techniques periodically after installation.

The captured thermal images may be received, for example, at processor 1204 that is communicatively coupled to infrared imaging module 1202. At block 1604, an NUC process may be performed on the captured thermal images to remove noise therein, for example, by using various NUC techniques disclosed herein.

At block 1606, the presence of one or more objects in the scene may be determined from the thermal images. In one embodiment, regions of contiguous pixels having temperature values in a specific range may be detected from the radiometrically calibrated thermal images. The temperature range may depend on the types of objects to be detected in the scene. For example, the detection operation may differentiate regions (or “blobs”) having a surface temperature distribution that is characteristic of a clothed person, a running vehicle, or other objects that may be present on thoroughfares. The thermal images and the blobs detected therein may be further processed and/or analyzed, for example, by performing various filtering operations and analyzing the size, shape, and/or thermal characteristics of the blobs, to ascertain the presence of one or more objects of certain types in the scene.

In another embodiment, the thermal images may be analyzed to detect one or more candidate foreground objects, for example, using background modeling techniques, edge detection techniques, or other foreground object detection techniques suitable for use with thermal images. The radiometric properties (e.g., surface temperature distribution) of the candidate objects may then be analyzed to determine whether they correspond to those of object types of interest. For example, a swinging tree branch or other spurious objects may initially be detected as a candidate foreground object, but its radiometric properties may then quickly reveal that it does not have a surface temperature distribution characteristic of a person or a running vehicle and thus is neither of these. As this example shows, object detection using the thermal images may be less susceptible to false detection of spurious objects compared with object detection techniques using visible light images. The size and shape of the candidate objects may also be analyzed, so that the presence of one or more objects of certain types may be ascertained based on the size, the shape, and the radiometric properties of the detected candidates.

In one aspect of this embodiment, background modeling techniques may be used to detect objects in the scene. Because the background (e.g., a portion of an empty thoroughfare) of the scene rarely changes and because thermal images are generally insensitive to changing lighting conditions, a background model (e.g., pixels that belong to a background) may be constructed with high accuracy, and a region of pixels different from the background (also referred to as a “region of interest”) may easily be distinguished as a candidate foreground object. As described above, the radiometric properties of such a region of interest (ROI) may then be analyzed to further ascertain whether the detected ROI likely represent an object of certain types or not.

In various embodiments, the various processing and analysis operations described for block 1606 may be omitted or included, and may be performed in any other order as appropriate for determining presence of occupants in an interior compartment of a vehicle. For example, in some embodiments, detecting hot “blobs” may be sufficient to determine presence of objects, whereas in other embodiments various thermal image analytics may be performed in combination to increase the accuracy of detection. Other appropriate techniques for detecting objects in thermal images may also be utilized for block 1606.

If one or more objects are detected at block 1606, various attributes associated with the detected objects may be determined at block 1608. As described for block 1606, the type (e.g., a person on foot, a person on a bicycle, an animal, a vehicle, or other types of objects that may be present on thoroughfare) of the detected object may be differentiated by analyzing the radiometric properties, the size and/or the shape of the detected objects. The detected objects may be further analyzed for a type determination at block 1608 in some embodiments when, for example, a type differentiation is not sufficiently made at block 1606 during object detection. Also, the count of the detected objects by type may be determined by tabulating or otherwise counting how many objects there are for each type of object.

The various attributes that may be determined also include the approximate locations of the detected objects. Since the thermal images may be scale/perspective calibrated thermal images, the approximate locations of the detected objects may be determined from the pixel coordinates of the detected objects in the thermal images. In addition, by tracking the locations of the detected objects in a series of the thermal images, the motion vectors (e.g., the direction and the speed of travel) of the detected objects may be estimated using appropriate video analytic techniques.

In some embodiments, if the detected object is a person, the posture of the person may be determined as well. By analyzing the profile and/or the aspect ratio of the detected person in the thermal images, it may be determined whether the person is upright (e.g., standing or walking), sitting, or lying down. Also, by analyzing the radiometric properties of the detected person (e.g., by aggregating temperature data associated with pixels that belong to the detected person), the approximate body temperature of the person may be determined. The posture and/or the body temperature may be determined using other appropriate thermal video/image analysis techniques as well.

At block 1610, further processing and/or analysis of the thermal images may be performed as desired for various application of process 1600. In one embodiment, the thermal images may be analyzed to determine various environmental conditions of the portion of the thoroughfare in the scene. For example, presence of water (e.g., from rain or otherwise collected on road surfaces), ice, or snow on the surface of the thoroughfare may be determined by analyzing the thermal images. Because radiometric properties (e.g., temperature, emission/absorption wavelengths, emissivity, reflectance, and transmittance) of water, ice, and snow are generally very distinct from those of surfaces of thoroughfares, the thermal images (e.g., thermal images that include images of thermal radiation from road surfaces) may be analyzed for variances that may be indicative of presence of such substances on the surfaces of the thoroughfare. Moreover, as discussed above in connection with optical element 1203 of FIG. 12, narrow-band filters may be utilized to increase sensitivity to infrared radiation absorbed or emitted from either ice, water, or both, so that variances created by presence of water or ice in the thermal images may be shown more clearly and in higher contrast to thermal radiation from dry road surfaces. In one embodiment, narrow-band filters may be applied selectively in a periodic fashion.

In another example, an ambient temperature of the portion of the thoroughfare may be determined from the thermal images. The ambient temperature may be determined by obtaining the surface temperature of a reference object (e.g., a non heat-generating object that is in a heat equilibrium with the surroundings) of known emissivity. The reference object may be placed at a location in the thoroughfare such that the thermal radiation from the reference object may be imaged at predetermined coordinates in the thermal images. The reference object may be an object placed in the thoroughfare for the purpose of obtaining an ambient temperature, or it may be any preexisting object or part of a preexisting object (e.g., a particular patch of a road surface not near a heat source). In another embodiment, a conventional temperature sensor may be used to determine the ambient temperature in place of, or in addition to, the ambient temperature detection operation using the thermal images.

In yet another example, an outbreak of fire in the portion of the thoroughfare may be detected by further analysis of the thermal images. Because typical temperatures of burning fire and flames are much higher (e.g., 1000° F. and above) than any normal heat-emitting object that may be present in thoroughfares, an outbreak of fire may be detected by distinguishing hot blobs having such high temperatures in the thermal images. Thus, in contrast to conventional fire alarms (e.g., smoke detectors) which are typically installed only within buildings and in other indoor areas due to their ineffectiveness outdoors, process 1600 may be utilized as a fire alarm for thoroughfares to detect outbreaks of fire on vehicles and other objects on thoroughfares.

Further processing and/or analysis of the thermal images may also include generating user-viewable thermal images (e.g., thermograms) by converting the thermal images using appropriate methods and algorithms. For example, the thermal data (e.g., temperature data) contained in the pixels of the thermal images may be converted into gray-scaled or color-scaled pixels to construct images that can be viewed by a person. User-viewable thermal images may optionally include a legend or scale that indicates the approximate temperature of corresponding pixel color and/or intensity. Such user-viewable images may be viewed by a person associated with, for example, traffic management authority or law enforcement for surveillance or traffic control. In one embodiment, process 1600 may further include capturing a visible light image of the portion of the thoroughfare with a visible light image camera, and fusing or combining the thermal images and the visible light images to generate user-viewable images having a higher definition and/or clarity, as described above in connection with processor 1204 of FIG. 12.

The various results, outcomes, or other data generated by the various analysis and processing operations of process 1600 (e.g., the determination of presence and attributes of objects, the determination of environmental conditions, and other operations described for 1606-1610) may be generally referred to as monitoring information. At block 1612, the monitoring information may be shared with, for example, other instances of system 1200 performing processing 1600 to monitor at least some other portions of the thoroughfare. For example, the monitoring information may be communicated over a network through communication module 1206 of FIG. 12. While the specific implementation of the sharing operation may be influenced by or otherwise depend on the underlying network layers and topology, in general the sharing operation may be based on location-aware communication among instances (or “nodes” in networking terminology) of system 1200. That is, each node may be made aware of the geopositional properties of itself, as well as of other nodes with which the monitoring information may be shared. Thus, for example, monitoring information may be shared among neighboring nodes (e.g., street lights 1450A-1450C of FIG. 14), among nodes having other forms of spatial locality (e.g., street lights in the same stretch of road, traffic lights and pedestrian crossing lights in the same intersection, or other geopositional groupings of nodes), or among nodes having other relationships. In this regard, in one embodiment, GPS receiver 1214 and/or electronic compass 1214 may be utilized to automatically obtain the geopositional information associated with a node when the node is first installed at a suitable location, without requiring manual input or adjustment. Communication module 1206 and/or processor 1204 may be further configured to share the geopositional information with other nodes to automatically discover the relative position mapping among nodes. Such automatic discovery may be performed using appropriate geolocation techniques in the field of computer networking. Thus, for example, when an additional node is installed, it may immediately and automatically connect to neighboring nodes to construct a wireless network and establish a relative position mapping among nodes. Such an installation process may be repeated on a city-wide basis to ultimately create a large and tightly interconnected network of nodes for intelligent monitoring of thoroughfares.

The monitoring information may also be transmitted to a central monitoring station (e.g., central monitoring station 1470), a traffic management system, a mobile device, a networked computer, or other external devices and systems. Since the communication of the monitoring information may be location-aware, the shared monitoring information may be utilized, for example, at the various external devices and systems to create a real-time map of traffic and/or environmental conditions, collect various statistics, or provide other beneficial information, as described above with respect to FIG. 14.

At block 1614, various actions may be taken based on the monitoring information. In some embodiments, the various actions that may be taken include generating various control signals to adjust operation of one or more adjustable components. For example, street lights, traffic lights, pedestrian/cyclist crossing lights, and/or other adjustable components may be adjusted based on the monitoring information, as described above with respect to adjustable component 1210 of FIG. 12.

In some embodiments, the various actions that may be taken include generating various alarms based on the monitoring information. For example, alarms may be generated to warn of potentially dangerous environmental conditions (e.g., icy or wet surface), a person in need of assistance, a vehicle collision, a fire, a crowd gathering, or other events that may be determinable from the monitoring information, as described above with respect to processor 1204 of FIG. 12.

In various embodiments, the various actions may be taken based at least in part on monitoring information shared by (e.g., transmitted by or received from) other nodes. Thus, as described above with respect to processor 1204, the various actions may be carried out in an intelligently coordinated manner.

Therefore, various embodiments of process 1600 may generate and share comprehensive monitoring information of thoroughfares, by capturing, processing, and analyzing thermal images and the radiometric data contained therein. Such comprehensive monitoring information may be advantageously utilized in process 1600 to generate various alarms for drivers and pedestrians, and intelligently adjust operation of various adjustable devices on thoroughfares. Such comprehensive monitoring information may be shared with a central monitoring station or other networked devices and systems, which may advantageously create a real-time map of traffic and/or environmental conditions, collect various statistics, or provide other beneficial information based on the monitoring information.

The various embodiments described herein may be used in accordance with example applications described above and others described below, and may be implemented with further features and/or components as appropriate for such applications. In various non-limiting examples, intelligent monitoring systems (e.g., installed at street lights and/or other locations) may be implemented to: detect various types of objects including pedestrians, cyclists, bicycles, animals, and vehicles; determine the direction and velocity of people and vehicles travelling under the street lights; count how many vehicles and people are present under each street light; adjust the illumination of the street lights (e.g., dimming or turning off when no person or vehicle is present, and brightening or turning on when present); communicate with other instances of the system installed at neighboring street lights to intelligently coordinate the adjustment of the street lights (e.g., opening up corridors of light based on the object location, direction, and speed); relay monitoring information to a traffic light control; communicate monitoring information to a server (e.g., Google™ Maps server) to permit creation of real-time city-wide traffic flow maps; communicate monitoring information to a municipal government to permit collection of statistics for city planning purposes; communicate monitoring information to mobile devices to allow for route planning; detect icy or wet road surfaces and relay the road surface condition to a variable message alert; detect and relay road surface temperature; detect crowds of people gathering and alert appropriate authorities; and/or detect and report stalled or illegally parked vehicles. According to one or more embodiments, the system may be configured for automatic location discovery (e.g., automatically discover the installed location relative to other street lights). As it may be appreciated, such systems can dramatically increase energy efficiency, thereby allowing all or portions of such systems (e.g., installed at street lights and/or other locations) to be powered by battery and/or solar panels.

Where applicable, various embodiments provided by the present disclosure can be implemented using hardware, software, or combinations of hardware and software. Also where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the invention. It should also be understood that numerous modifications and variations are possible in accordance with the principles of the invention. Accordingly, the scope of the invention is defined only by the following claims.

What is claimed is:

1. A system comprising:
an infrared imaging module disposed at a location along a thoroughfare, the infrared imaging module comprising a focal plane array (FPA) configured to capture thermal images of a scene comprising at least a portion of the thoroughfare; and
a processor in communication with the infrared imaging module, the processor configured to:
analyze the thermal images to determine a presence of one or more objects and at least one attribute associated with the objects in the scene, and
generate monitoring information based on the determination of the presence and the attribute.

2. The system of claim 1, wherein:
the processor is co-located with the infrared imaging module at the location along the thoroughfare.

3. The system of claim 1, further comprising:
a communication module configured to transmit the monitoring information to at least one of a central monitoring station, a mobile device, or a networked computer.

4. The system of claim 1, wherein:
the infrared imaging module is located at a street light, a traffic light, a crosswalk light, an inner wall of a tunnel, a street sign, or a road sign.

5. The system of claim 1, wherein:
the processor is further configured to analyze the thermal images to determine a surface condition associated with the portion of the thoroughfare; and
the monitoring information identifies the surface condition.

6. The system of claim 5, wherein:
the surface condition is at least one of a dry, wet, rainy, snowy, or icy condition; and
the processor is further configured to generate an alarm based on the surface condition.

7. The system of claim 1, wherein:
the monitoring information identifies at least one of a type, a count, a location, a direction of travel, and/or a speed associated with the one or more objects.

8. The system of claim 7, wherein:
the object is a person;
the monitoring information further identifies a posture of the person; and
the processor is further configured to:
determine whether the person needs assistance based on the monitoring information, and
generate an alarm based on the determination of the need for assistance.

9. The system of claim 7, wherein:
the processor is further configured to generate a control signal to adjust operation of an adjustable component based on the monitoring information.

10. The system of claim 9, wherein:
the adjustable component is at least one of a street light, a traffic light, or a crosswalk signal.

11. The system of claim 10, wherein:
the control signal is generated to turn on, turn off, or adjust an intensity of the street light.

12. The system of claim 10, wherein:
the street light has a selectable output color;
the control signal is generated to change the output color; and
the output color is selected based on a type of an alarm generated by the processor.

13. The system of claim 9, wherein the infrared imaging module is a first infrared imaging module, the location is a first location, the thermal images captured by the first infrared imaging module are first thermal images, the scene is a first scene, the portion of the thoroughfare is a first portion of the thoroughfare, the processor is a first processor, and the monitoring information is first monitoring information, the system further comprising:
a second infrared imaging module disposed at a second location along the thoroughfare, the second infrared imaging module comprising an FPA configured to capture second thermal images of a second scene comprising at least a second portion of the thoroughfare;
a second processor configured to:
analyze the second thermal images to determine a presence of one or more objects and at least one attribute associated with the objects in the second scene, and
generate second monitoring information based on the determination of the presence and the attribute; and
a communication module configured to transmit the second monitoring information to the first processor, the first processor configured to generate the control signal based at least in part on the second monitoring information.

14. The system of claim 13, wherein
the adjustable component is a street light; and
the first processor is configured to generate the control signal to increase an intensity of the street light if the second monitoring information indicates that the one or more objects are expected to move into an illumination area of the street light.

15. The system of claim 1, wherein:
the thermal images are unblurred thermal images of the scene;
the infrared imaging module is configured to capture intentionally blurred thermal images of the scene; and
the processor is configured to determine a plurality of non-uniform correction (NUC) terms based on the intentionally blurred thermal images and apply the NUC terms to the unblurred thermal images to remove noise form the unblurred thermal images.

16. A method comprising:
capturing, at a focal plane array (FPA) of an infrared imaging module, thermal images of a scene comprising at least a portion of a thoroughfare, wherein the infrared imaging module is disposed at a location along the thoroughfare such that the portion of the thoroughfare is within a field of view (FOV) of the infrared imaging module;
analyzing the thermal images to determine a presence of one or more objects and at least one attribute associated with the objects in the scene; and
generating monitoring information based on the determination of the presence and the attribute.

17. The method of claim 16, further comprising:
transmitting the monitoring information to at least one of a central monitoring station, a mobile device, or a networked computer.

18. The method of claim 16, wherein:
the analyzing comprises determining a surface condition associated with the portion of the thoroughfare; and
the monitoring information identifies the surface condition.

19. The method of claim 18, further comprising:
generating an alarm based on the surface condition, the surface and weather condition being at least one of a dry, wet, rainy, snowy, or icy condition.

20. The method of claim 16, wherein:
the monitoring information identifies at least one of a type, a count, a position, a direction of travel, and/or a speed associated with the one or more objects.

21. The method of claim 20, wherein the object is a person, and the monitoring information further identifies a posture of the person, the method further comprising:
determining whether the person needs assistance based on the monitoring information; and
generating an alarm based on the determination of the need for assistance.

22. The method of claim 20, further comprising:
generating a control signal to adjust operation of an adjustable component based on the monitoring information.

23. The method of claim 22, wherein:
the adjustable component is at least one of a street light, a traffic light, or a crosswalk signal.

24. The method of claim 23, wherein:
the generating the control signal comprises configuring the control signal for turning on, turning off, or adjusting an intensity of the street light.

25. The method of claim 23, wherein:
the street light has a selectable output color;
the generating the control signal comprises configuring the control signal for changing the output color; and
the output color is selected based on a type of an alarm generated by the processor.

26. The method of claim 22, wherein the infrared imaging module is a first infrared imaging module, the location is a first location, the thermal images captured by the first infrared imaging module are first thermal images, the scene is a first scene, the portion of the thoroughfare is a first portion of the thoroughfare, and the monitoring information is first monitoring information, the method further comprising:
capturing, at an FPA of a second infrared imaging module, second thermal images of a second scene comprising at least a second portion of the thoroughfare, wherein the second infrared imaging module is disposed on a second location along the thoroughfare such that the second portion of the thoroughfare is within an FOV of the second infrared imaging module;
analyzing the second thermal images to determine a presence of one or more objects and at least one attribute associated with the objects in the second scene;
generating second monitoring information based on the determination of the presence and the attribute; and
generating the control signal based at least in part on the second monitoring information.

27. The method of claim 26, wherein
the adjustable component is a street light; and
the generating the control signal comprises generating the control signal to increase an intensity of the street light if the second monitoring information indicates that the one or more objects are expected to move into an illumination area of the street light.

28. The method of claim 16, wherein the thermal images are unblurred thermal images, the method further comprising:
capturing intentionally blurred thermal images of the scene;
determining a plurality of non-uniform correction (NUC) terms based on the intentionally blurred thermal images; and
applying the NUC terms to the unblurred thermal images to remove noise from the unblurred thermal images.
